(19) United States
(12) Patent Application Publication
(10) Pub. No.: US 2026/0170683 A1
(43) Pub. Date: Jun. 18, 2026

(54) PERCEPTION AND PLANNING TECHNIQUES FOR OBJECT INTERACTIONS IN ROBOTICS SYSTEMS AND APPLICATIONS

(71) Applicant: NVIDIA Corporation, Santa Clara, CA (US)

(72) Inventors: Rui Zhang, Beijing (CN); Tao Li, Beijing (CN); Jaming Shu, Beijing (CN); Weihua Zhang, Beijing (CN); Junjie Lai, Beijing (CN)

(21) Appl. No.: 19/028,483

(22) Filed: Jan. 17, 2025

(30) Foreign Application Priority Data
Dec. 13, 2024 (CN) 2024118445605

(51) Int. Cl. G06T 7/73; B25J 9/16; G06V 10/26; G06V 10/774

(52) U.S. Cl. CPC G06T 7/74; B25J 9/1697; G06V 10/26; G06V 10/774; G06T 2207/10028; G06T 2207/20081

(57) ABSTRACT

In various examples, perception and planning techniques for interacting with objects are described herein. Systems and methods described herein may determine poses associated with objects located within a container or other partially enclosed space. For instance, image data representing one or more images of the objects may be segmented to generate segmentation masks associated with the objects. The segmentation masks may then be scored to select an object, such as the object that is associated with the highest-scoring segmentation mask. Additionally, one or more techniques may then be used to determine a pose associated with the object, where the pose includes at least a location and/or orientation of the object within the container. The pose may then be used to determine one or more operations for a machine to perform to interact with the object, such as removing the object from a container.

### BACKGROUND

A common task in robotics includes removing objects that are randomly placed on and/or within a container or other space—such as a bin, a shelf, a table, and/or a rack—using a machine. For instance, the machine may include a manipulator—such as an arm (e.g., of a humanoid robot), an extender, a lifter, and/or the like—that is configured to individually remove the objects from a first location to a second location (e.g., from inside of a container to placement outside of the container). However, performing such a task may be challenging based on one or more factors, such as the positions and/or orientations of the objects being initially unknown, the objects being stacked on top of one another, and/or the objects being at least partially occluded within the container. As such, conventional systems may divide the task into perception processing followed by planning processing, where perception processing includes detecting the objects and/or poses of the object within the container and planning processing includes determining motion for the machine to remove the detected objects.

Conventional systems may use one or more techniques to perform perception processing. For instance, one conventional technique for performing perception processing includes using point cloud clustering and matching to identify individual objects located within a container. However, the accuracy of point cloud clustering and matching may be limited and/or may become stuck or frozen at a local optimum. Another conventional technique for performing perception processing includes deep learning with pose estimation. For instance, this conventional approach uses machine learning models that are trained to directly estimate the pose (e.g., the location and orientation) of each object within the container. However, performing such training may require a large amount of time and/or computing resources. Additionally, without performing this training, the machine learning models may be unable to determine poses for other types of objects.

### SUMMARY

Embodiments of the present disclosure relate to perception and planning techniques for interacting with objects in partially enclosed spaces—such as containers, shelves, boxes, etc.—although the techniques described herein may be used for an object at any location. Systems and methods described herein may determine poses associated with objects located within a partially enclosed space using, for instance, image data representing one or more images of the objects. The images may be segmented to generate segmentation masks associated with the objects, and the segmentation masks may then be scored to select an object, such as the object that is associated with the highest scoring segmentation mask. Additionally, one or more techniques may then be used to determine a pose associated with the object, where the pose includes at least a location and/or orientation of the object within the partially enclosed space. Systems and methods are then described herein that use at least the pose to determine one or more operations for a machine to perform to interact with the object. For instance, the pose may be used to determine motion that satisfies a collision-check and/or is related to an optimal angle for interacting with the object. In some examples, the motion may be associated with the machine at least picking up and removing the object from the partially enclosed space.

In contrast to conventional systems, the systems of the present disclosure, in some embodiments, use image segmentation to select objects and/or determine poses for the selected objects within the partially enclosed space (e.g., perform the perception processing). As such, the systems of the present disclosure are able to select any object located within the space, unlike the conventional systems that use point cloud clustering and are limited to local optimum. Additionally, the systems of the present disclosure are able to select the objects and/or determine poses for the objects without preforming special training of machine learning models, unlike the conventional systems that use deep learning with pose estimation. By being capable of selecting objects and/or determining poses of objects without special training, the systems of the present disclosure may operate with various types of objects, reduce the amount of time it takes to perform the object removal task, and/or reduce the amount of computing resources required to perform the object removal or movement task.

### BRIEF DESCRIPTION OF THE DRAWINGS

The present systems and methods for perception and planning techniques for interacting with objects are described in detail below with reference to the attached drawing figures, wherein:

FIG. 1 illustrates an example data flow diagram for a process of causing a machine to interact with objects located within a partially enclosed space, in accordance with some embodiments of the present disclosure;

FIG. 2 illustrates an example of a container that includes objects, in accordance with some embodiments of the present disclosure;

FIGS. 3A-3B illustrate an example of performing image segmentation to generate segmentation masks associated with objects, in accordance with some embodiments of the present disclosure;

FIGS. 4A-4C illustrate an example of ranking segmentation masks associated with objects, in accordance with some embodiments of the present disclosure;

FIGS. 5A-5C illustrate an example of determining a pose associated with an object, in accordance with some embodiments of the present disclosure;

FIGS. 6A-6B illustrate an example of ranking different grasp types associated with an object, in accordance with some embodiments of the present disclosure;

FIG. 7 illustrates an example of performing a collision-check associated with motion paths for interacting with an object, in accordance with some embodiments of the present disclosure;

FIG. 8 illustrates an example of causing a machine to perform one or more operations for interacting with objects located within a partially enclosed space, in accordance with some embodiments of the present disclosure;

FIG. 9 illustrates an example of one or more systems that are configured to perform at least a portion of the processes described herein, in accordance with some embodiments of the present disclosure;

FIG. 10 illustrates a flow diagram showing a method for using sensor data segmentation to interact with an object located within a partially enclosed space, in accordance with some embodiments of the present disclosure;

FIG. 11 illustrates a flow diagram showing a method for using multiple poses to perform a collision-check when controlling a machine, in accordance with some embodiments of the present disclosure;

FIG. 12 illustrates a flow diagram showing a method for using a failed mask list to rank segmentation masks for performing a collision-check, in accordance with some embodiments of the present disclosure;

FIG. 13A is an illustration of an example autonomous vehicle, in accordance with some embodiments of the present disclosure;

FIG. 13B is an example of camera locations and fields of view for the example autonomous vehicle of FIG. 13A, in accordance with some embodiments of the present disclosure;

FIG. 13C is a block diagram of an example system architecture for the example autonomous vehicle of FIG. 13A, in accordance with some embodiments of the present disclosure;

FIG. 13D is a system diagram for communication between cloud-based server(s) and the example autonomous vehicle of FIG. 13A, in accordance with some embodiments of the present disclosure;

FIG. 14 is a block diagram of an example computing device suitable for use in implementing some embodiments of the present disclosure; and

FIG. 15 is a block diagram of an example data center suitable for use in implementing some embodiments of the present disclosure.

### DETAILED DESCRIPTION

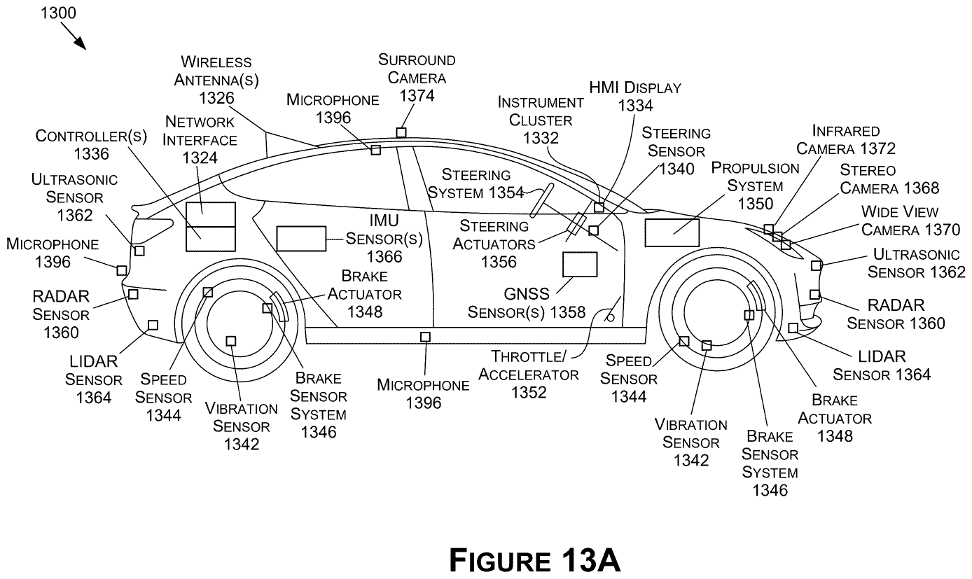

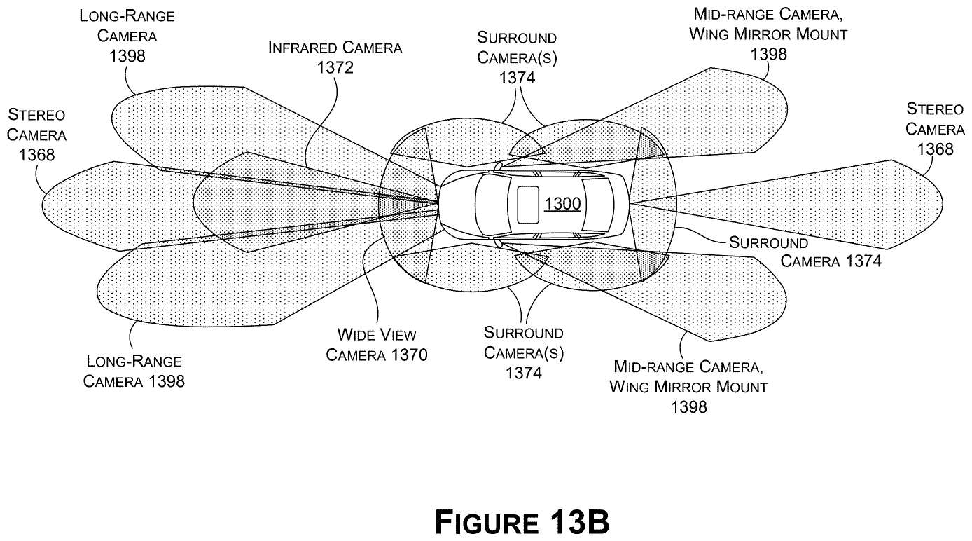

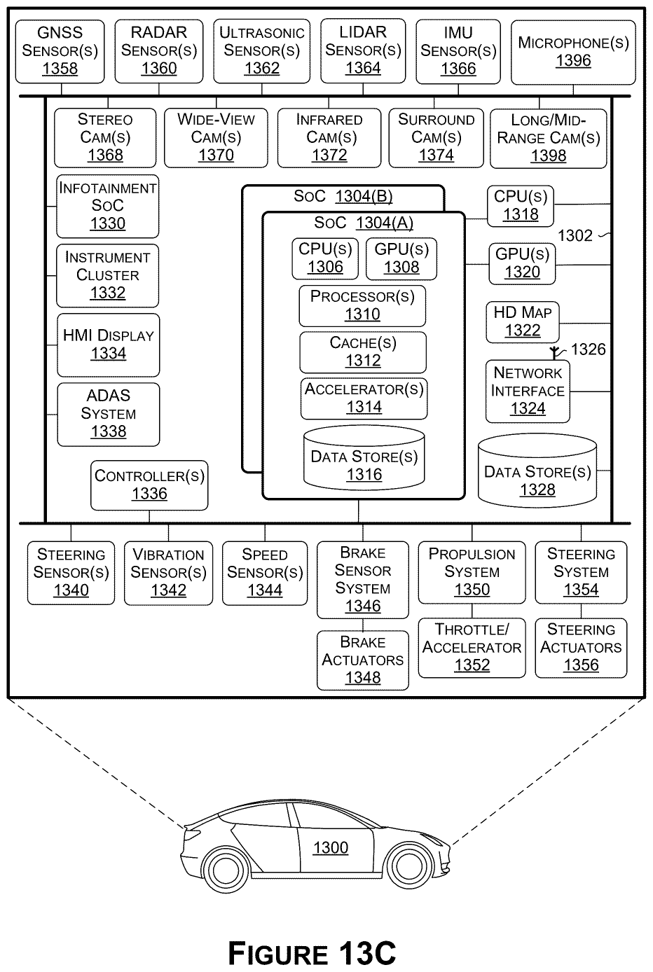

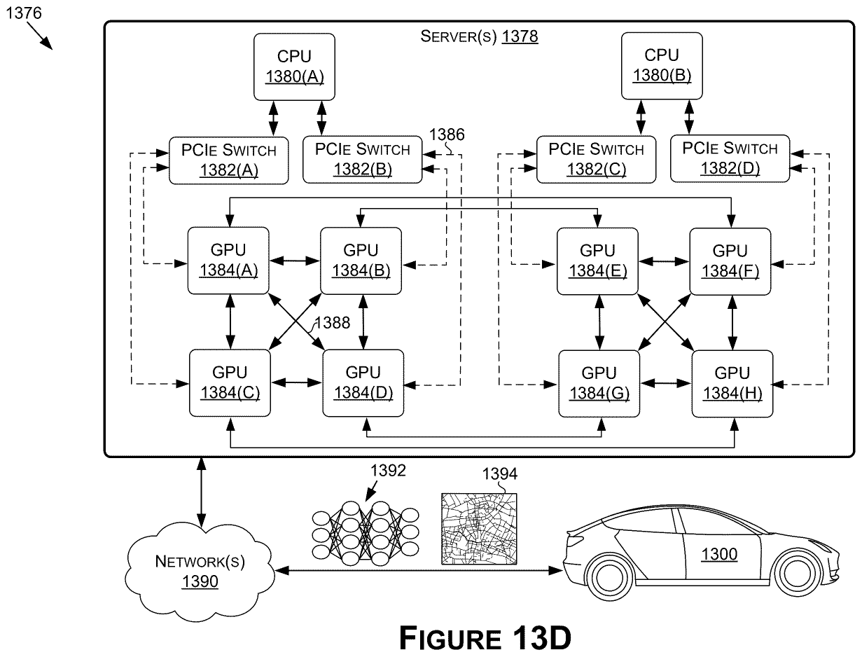

Systems and methods are disclosed for perception and planning techniques for interacting with objects—such as objects located within partially enclosed spaces likes containers, shelves, boxes, conveyer belts, etc. Although the present disclosure may be described with respect to an example autonomous or semi-autonomous robot or machine 1300 (alternatively referred to herein as “vehicle 1300,” “ego-vehicle 1300,” “ego-machine 1300,” or “robot 1300,” an example of which is described with respect to FIGS. 13A-13D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to interacting with objects in containers, this is not intended to be limiting, and the systems and methods described herein may be used in augmented reality, virtual reality, mixed reality, robotics, security and surveillance, autonomous or semi-autonomous machine applications, and/or any other technology spaces where interacting with objects in containers.

For instance, a system(s) may obtain sensor data using one or more sensors of a machine—such as a semi-autonomous and/or autonomous robot (e.g., a humanoid robot, a robotic arm, a forklift, an autonomous mobile robot (AMR), etc.)—that is interacting with objects located within a partially enclosed space—such as a container. Although primarily described with respect to containers herein, the systems and methods described herein may be used for any type of object located in any location, including but not limited to partially enclosed spaces, fully enclosed spaces, unenclosed spaces, etc. As such, where container is used herein, container may be replaced with any other object location without departing from the scope of the present disclosure. As described herein, the sensor data may include, but is not limited to, image data obtained using one or more image sensors, LiDAR data obtained using one or more LiDAR sensors, RADAR data obtained using one or more RADAR sensors, and/or any other type of sensor data obtained using any other type of sensor. Additionally, the container may include, but is not limited to, a bin, a shelf, a table, a bucket, a box, and/or any other type of container for which objects may be located within and/or on. Furthermore, the objects may include, but are not limited to, toys, mechanical parts, manufactured parts, packages, tools, sporting equipment, three-dimensional (3D) shapes, and/or any other type of object. In some examples, each of the objects included in the container may include a same type of object, such as a same mechanical part. However, in other examples, the objects included in the container may include various types of objects, such as different types of mechanical parts.

The system(s) may then process the sensor data using one or more segmentation techniques in order to generate representations associated with the objects. For instance, if the sensor data includes image data representing one or more images, the system(s) may process the image data using one or more image segmentation models to generate one or more segmentation masks associated with one or more of the objects. In some examples, the system(s) may generate a respective segmentation mask associated with each object depicted by the image(s). In some examples, the system(s) may generate a respective segmentation mask associated with a threshold number of the objects depicted by the image(s). In any of the examples, the system(s) may then use the segmentation masks to select an object for interaction.

For instance, the system(s) may use one or more techniques to determine scores associated with the segmentation masks. In some examples, the system(s) may determine the scores using similarities between the shapes of the segmentation masks and a shape of a reference segmentation mask associated with the objects. For example, the system(s) may determine the scores by calculating Hu-Moments distances between the segmentation masks and the reference segmentation mask. In some examples, the system(s) may determine the scores using areas associated with the segmentation masks and one or more threshold areas. For example, the system(s) may determine the scores based on determining whether the areas of the segmentation masks are within a range that is associated with a minimum threshold area and a maximum threshold area. Still, in some examples, the system(s) may determine the scores using both (1) the similarities between the shapes of the segmentation masks and the shape of the reference segmentation mask (2) and the areas associated with the segmentation masks and the one or more threshold areas. In any of the examples, the system(s) may then rank the segmentation masks using the scores, such as starting at the highest score and then in descending order. Additionally, the system(s) may use the ranking to select an object, such as by selecting the object that is associated with the highest score.

The system(s) may then determine a pose associated with the object, where the pose may include a location (e.g., the x-coordinate location, the y-coordinate location, and/or the z-coordinate location) and/or an orientation (e.g., the roll, the pitch, and/or the yaw). In some examples, to determine the pose, the system(s) may initially determine a coarse pose associated with the object using one or more machine learning models. For instance, the machine learning model(s) may process input data representing at least the image(s), one or more depth images that represent the objects (and/or other depth information associated with the objects), the segmentation mask associated with the object, and a three-dimensional (3D) mesh of the object and, based at least on the processing, output data representing the coarse pose. The system(s) may then refine the coarse pose to determine a final pose associated with the object. For instance, the system(s) may determine the final pose using a first point cloud associated with the coarse pose and a 3D mesh associated with the object, a second point cloud associated with depth information corresponding to the object, and one or more algorithms (e.g., one or more iterative closest point algorithms). However, in other examples, the system(s) may use the coarse pose as the final pose associated with the object.

The system(s) may then use the pose to determine one or more operations associated with causing the machine to interact with the object. As described herein, in some examples, the operation(s) associated with interacting with the object may include using a manipulator of the machine—such as an arm, a hand, an extender, a lifter, an end-effector, and/or the like—to remove the object from the container and/or place the object outside of the container. As such, the operation(s) may include causing the machine to move the manipulator into the container, pick the object up using one or more grasping mechanisms of the manipulator, and then move the manipulator back outside of the container while still holding the object. However, in other examples, the operation(s) associated with interacting with the object may include any other type of interaction, such as touching the object, pushing the object, pulling the object, attaching another object (e.g., a label) to the object, and/or so forth.

In some examples, the system(s) may initially determine one or more grasp types that the machine may use to grab the object. As described herein, a grasp type may be determined using the pose associated with the object, where the grasp type is associated with at least an axis and a translation along the axis. The system(s) may then rank the grasp type(s) based at least on the axes of the individual grasp type(s), the translations along the axes, and a reference vector, such as the up vector (and/or any other vector). For example, and when there are multiple grasp types, the system(s) may rank the grasp types based on dot products between the axes of the grasp types and the up vector. In such an example, a grasp type that includes an axis that is closer to the up vector may be ranked higher than a grasp type that includes an axis that is farther from the up vector.

The system(s) may also analyze one or more motion paths using a collision-check, where an individual motion path may be associated with a grasp type. For instance, and for a motion path, the system(s) may analyze the motion path to determine whether the machine collides with the container and/or one or more other objects when navigating along the motion path to grab the object using the associated grasp type. In some examples, the system(s) may analyze each of the motion path(s) performing this collision-check. However, in other examples, the system(s) may analyze only a portion of the motion path(s). For example, the system(s) may analyze a collision path that is associated with the highest-ranking grasp type. If the system(s) determines that the collision path satisfies the collision-check (e.g., there is no collision), then the system(s) may select the motion path. However, if the system(s) determines that the collision path does not satisfy the collision-check (e.g., there is a collision), then the system(s) may analyze a next motion path associated with a second highest ranking grasp type. Additionally, the system(s) may continue to perform these processes until identifying a motion path that satisfies the collision-check and/or until analyzing all of the motion path(s).

The system(s) may use one or more techniques to perform the collision-check associated with a motion path. For instance, the system(s) may determine one or more poses of the machine (e.g., the manipulator) while navigating along the motion path to interact with the object. In some examples, the pose(s) may include at least a pre-grasp pose that is associated with the machine moving towards the object and a target pose that is associated with the machine interacting with the object. In such examples, the pre-grasp pose may be determined based on moving in a normal direction from a surface associated with the grasp type and away from the object for a threshold distance (e.g., 0.3 meters). The system(s) may then use one or more collision techniques—such as Random-Exploring Random Tree (RRT), Lula RRT, cuRobo, Edge Collision Detection, Circle Point Collision, Rectangle Point Collision, and/or any other collision detection technique—to determine whether there is a collision associated with the pose(s). If the system(s) determines that there is no collision associated with the pose(s), then the system(s) may determine that the motion path satisfies the collision-check. However, if the system(s) determines that there is a collision associated with at least one of the pose(s), then the system(s) may determine that the motion path does not satisfy the collision-check.

If the system(s) determines that a motion path satisfies the collision-check (and/or a higher-ranking motion path if multiple motion paths satisfy the collision-check), then the system(s) may use one or more techniques to generate data for causing the machine to move along a trajectory that is associated with the motion path in order to interact with the object. For instance, the data may cause the machine to move the manipulator along the trajectory towards the object, grab the object once within proximity to the object, and then move the manipulator from inside the container to back outside the container while grasping the object. In some examples, the data may cause the machine to perform additional operations, such as placing the object at one or more locations (e.g., on another object, within another object, etc.). Additionally, the system(s) may continue to perform these processes in order to cause the machine to perform similar tasks with respect to other objects associated with the container. For example, the system(s) may perform these processes to remove one or more additional objects (e.g., each object) from the container.

As described herein, in some examples, the system(s) may determine that no motion path satisfies the collision-check (e.g., each motion path causes a collision with respect to the machine). In such examples, the system(s) may add the object (also referred to as the “failed object) and/or the segmentation mask (also referred to as the “failed segmentation mask”) associated with the object to a list of failed objects. Additionally, the system(s) may perform one or more of the processes described herein to determine a new object for interacting. For instance, the system(s) may again use the one or more segmentation models to generate the segmentation masks associated with the objects. The system(s) may also again determine the scores associated with the segmentation masks and rank the segmentation masks based at least on the scores. However, since the failed object did not satisfy the collision-check, the system(s) may reduce the score for a potential segmentation mask that is associated with the failed object such that the failed object is not again selected using the ranking.

In some examples, to identify the potential segmentation mask, the system(s) may compare the new segmentation masks generated for the objects to the failed segmentation mask associated with the failed object. Based at least on the comparison, the system(s) may determine amounts of overlap between the new segmentation masks and the failed segmentation mask. The system(s) may then determine that a new segmentation mask is associated with the failed object based at least on the amount of overlap associated with the new segmentation mask satisfying (e.g., being equal to or greater than) a threshold amount of overlap (e.g., 90%). While this is just one example technique for how the system(s) may determine that a new segmentation mask is associated with the failed object, in other examples, the system(s) may use additional and/or alternative techniques to determine that the new segmentation mask is associated with the failed object.

In some examples, the mode(s) (e.g., machine learning models, deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Additionally, in some embodiments, the systems and methods described herein may be performed within a simulation environment (e.g., NVIDIA's DriveSIM, ISAAC GYM, and/or ISAAC SIM) using simulated data (e.g., simulated sensor data of simulated sensors of a virtual or simulated machine). For example, simulated sensor data and/or map data (simulated or real) may be used to perform various operations within the simulation environment, such as to generate the simulation data and/or operate a machine. These simulated operations may be used to test performance of the underlying algorithms, systems, and/or processes prior to deploying them in the real-world. In some instances, the simulation may be used to generate synthetic training data—e.g., training data including landmarks, features, objects, etc.—so that the synthetic training data (in addition to or alternatively from real-world data) may then be processed to perform one or more of the operations described herein.

In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

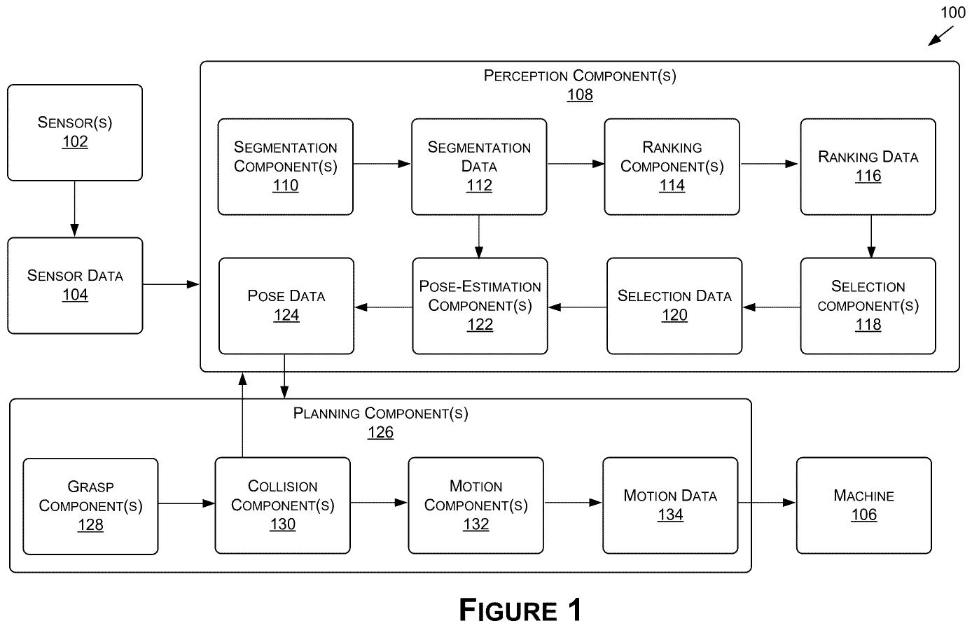

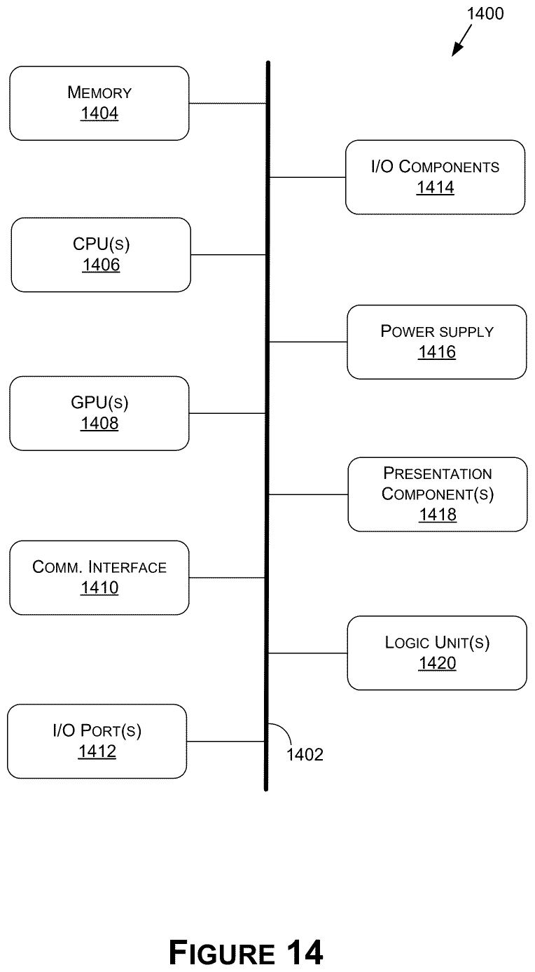

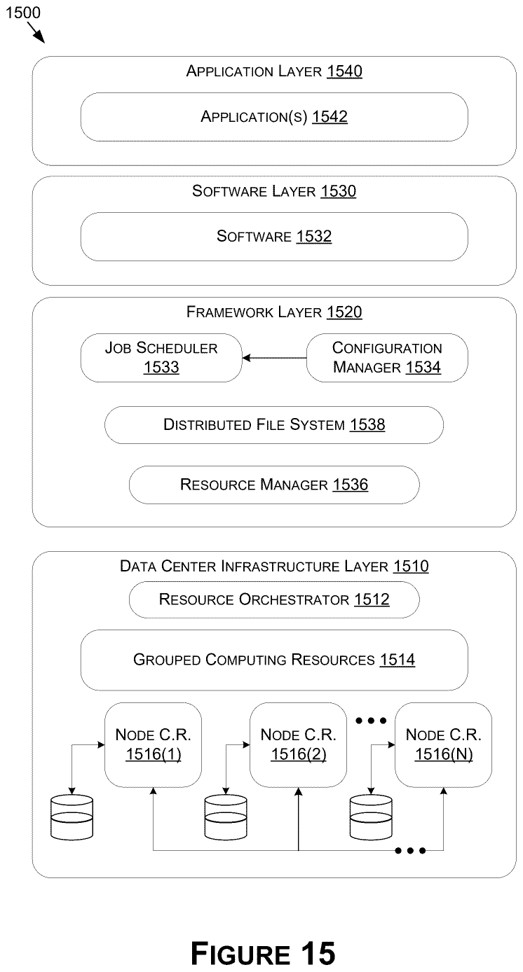

With reference to FIG. 1, FIG. 1 illustrates an example data flow diagram for a process 100 of causing a machine to interact with objects located within a container, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1300 of FIGS. 13A-13D, example computing device 1400 of FIG. 14, and/or example data center 1500 of FIG. 15.

For instance, the process 100 may include one or more sensors 102 generating sensor data 104. As described herein, the sensor data 104 may include, but is not limited to, image data obtained using one or more image sensors, LiDAR data obtained using one or more LiDAR sensors, RADAR data obtained using one or more RADAR sensors, and/or any other type of sensor data obtained using any other type of sensor. In some examples, the sensor(s) 102 may be included as part of and/or associated with a machine 106 that is configured to interact with objects located within and/or on a container. Additionally, or alternatively, in some examples, the sensor(s) 102 may be located external to the machine 106. In any of the examples, and as described herein, the sensor data 104 may represent at least a portion of the container that includes the objects.

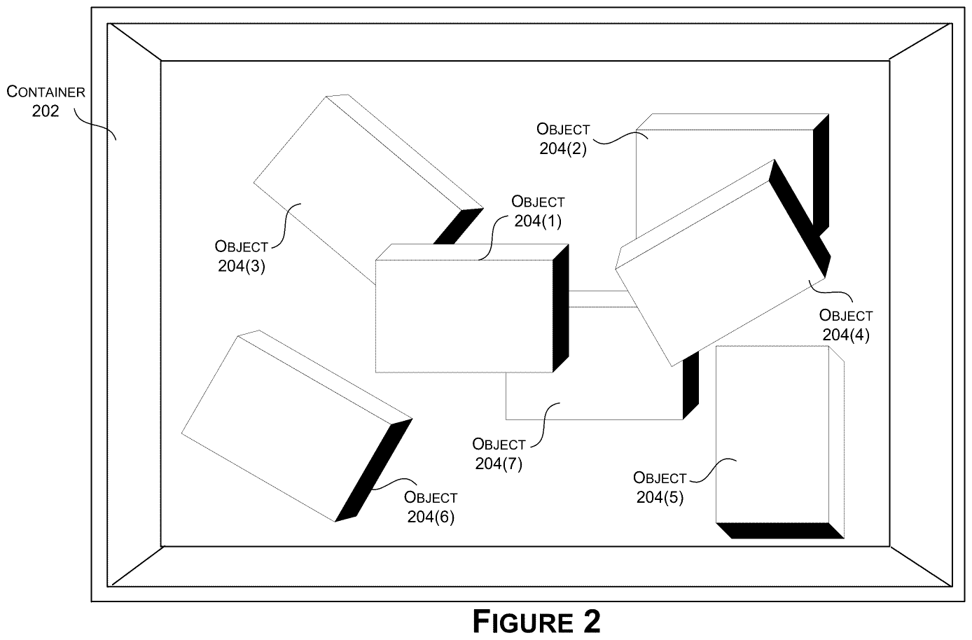

For instance, FIG. 2 illustrates an example of a container 202 that includes objects 204(1)-(7) (also referred to singularly as “object 204” or in plural as “objects 204”), in accordance with some embodiments of the present disclosure. In the example of FIG. 2, the container 202 may include a bin, where the bin includes a compartment that is holding seven of the objects 204. Additionally, the objects 204 may include any type of object that is cuboid in shape. However, in other examples, the container 202 may include any other type of container holding any number of the objects 204 and/or objects within the container 202 may include any other type of object.

Referring back to the example of FIG. 1, the process 100 may include one or more perception components 108 determining information associated with the objects located within the container. As described herein, in some examples, the information associated with an object may include the pose of the object within the container, such as the location (e.g., the x-coordinate location, the y-coordinate location, and/or the z-coordinate location) and the orientation (e.g., the roll, the pitch, and/or the yaw). Additionally, in some examples, the information associated with the objects may indicate a next object that the machine 106 is to interact with within the container. For example, if the machine 106 is configured to remove objects from the container, then the information may indicate the pose for the next object that the machine 106 should attempt to remove from the container.

For instance, the process 100 may include the perception component(s) 108 using one or more segmentation components 110 to perform one or more object detection and/or segmentation operations with respect to at least a portion of the sensor data 104. In some examples, the segmentation component(s) 110 may include and/or use one or more machine learning models, one or more neural networks, one or more classifiers, one or more algorithms, and/or any other type of processing component that performs one or more of the operations described herein. For instance, if the sensor data 104 includes image data representing one or more images of the objects, then the segmentation component(s) 110 may process the image data using one or more machine learning models in order to generate segmentation masks associated with the objects as represented by the image(s), where the segmentation masks may be represented by segmentation data 112. In some examples, the segmentation component(s) 110 may use any type of image segmentation to generate the segmentation masks associated with the objects.

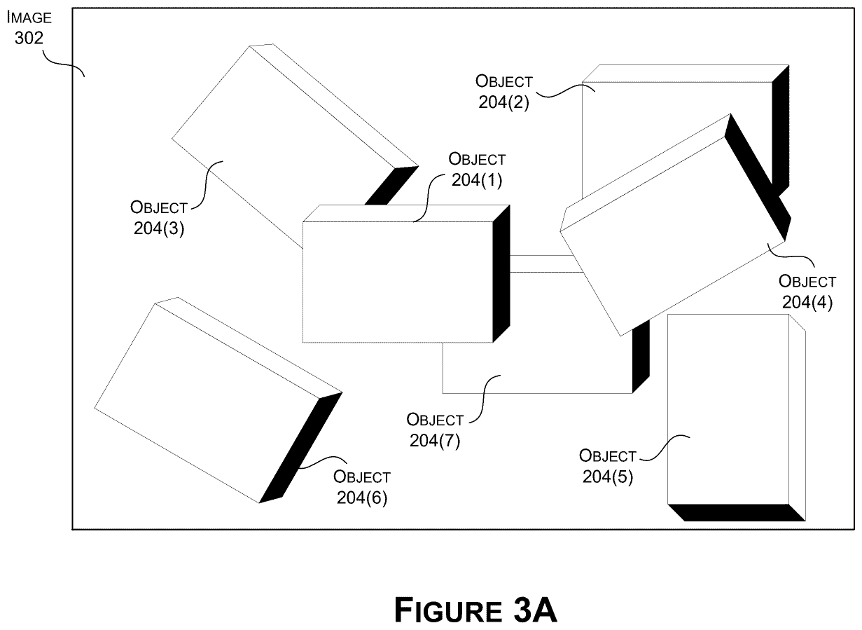

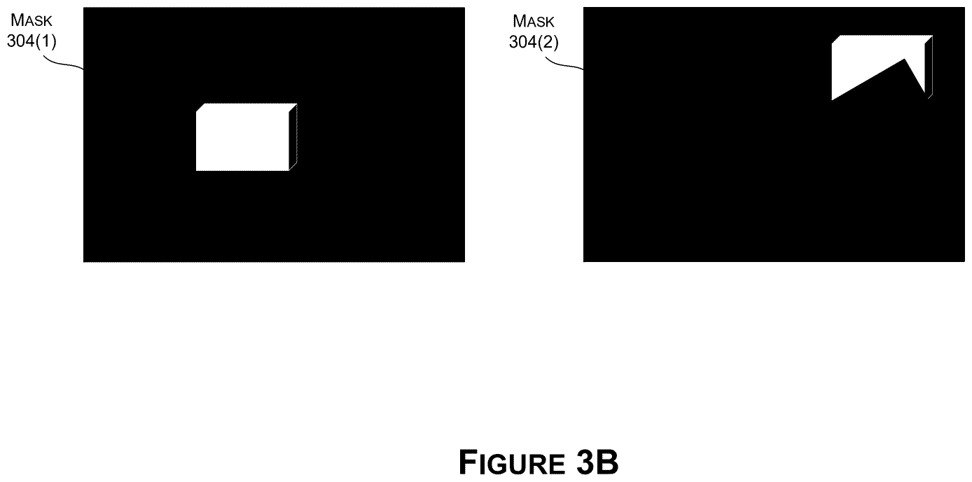

For instance, FIGS. 3A-3B illustrate an example of performing image segmentation to generate segmentation masks associated with objects, in accordance with some embodiments of the present disclosure. As shown by the example of FIG. 3A, a machine may initially use one or more image sensors to generate image data representing an image 302 of at least the interior compartment of the container 202. As such, the image 302 may represent at least the objects 204 as currently oriented within the container 202. The segmentation component(s) 110 may then process the image data in order to detect the objects 204 within the container 202 and/or generate segmentation masks associated with the objects 204 as represented by the image 302. As described herein, the segmentation component(s) 110 may perform any type of image segmentation technique to generate the segmentation masks associated with the objects.

For an example, the segmentation component(s) 110 may process the image data using one or more machine learning models that classify points (e.g., pixels) of the image 302. The segmentation component(s) 110 may then detect the objects 204 as represented by the image 302 using the classifications associated with the points. For instance, the segmentation component(s) 110 may determine that first points are associated with the first object 204(1) based at least on the first points being associated with a first classification, determine that second point are associated with the second object 204(2) based at least on the second points being associated with a second classification, and/or so forth. As shown by the example of FIG. 3B, the segmentation component(s) 110 may then use the segmentations of the points to generate at least a first segmentation mask 304(1) associated with the first object 204(1) and a second segmentation mask 304(2) associated with the second object 204(2). However, in other examples, the segmentation component(s) 110 may further generate one or more additional segmentation masks associated with one or more additional objects 204(3)-(7).

Referring back to the example of FIG. 1, the process 100 may include the perception component(s) 108 using one or more ranking components 114 to rank the segmentation masks associated with the objects, where the ranking is represented by ranking data 116. For instance, the ranking component(s) 114 may use one or more techniques to determine scores associated with the segmentation masks. In some examples, the ranking component(s) 114 may determine the scores using similarities between the shapes of the segmentation masks and a shape of a reference segmentation mask associated with the objects. For example, the ranking component(s) 114 may determine the scores by calculating Hu-Moments distances between the segmentation masks and the reference segmentation mask. In some examples, the ranking component(s) 114 may determine the scores using areas associated with the segmentation masks and one or more threshold areas. For example, the ranking component(s) 114 may determine the scores based on determining whether the areas of the segmentation masks are within a range that is associated with a minimum threshold area and a maximum threshold area. Still, in some examples, the ranking component(s) 114 may determine the scores using both (1) the similarities between the shapes of the segmentation masks and the shape of the reference segmentation mask and (2) the areas associated with the segmentation masks and the one or more threshold areas. In any of the examples, the ranking component(s) may then rank the segmentation masks using the scores, such as starting at the highest score and moving in descending order.

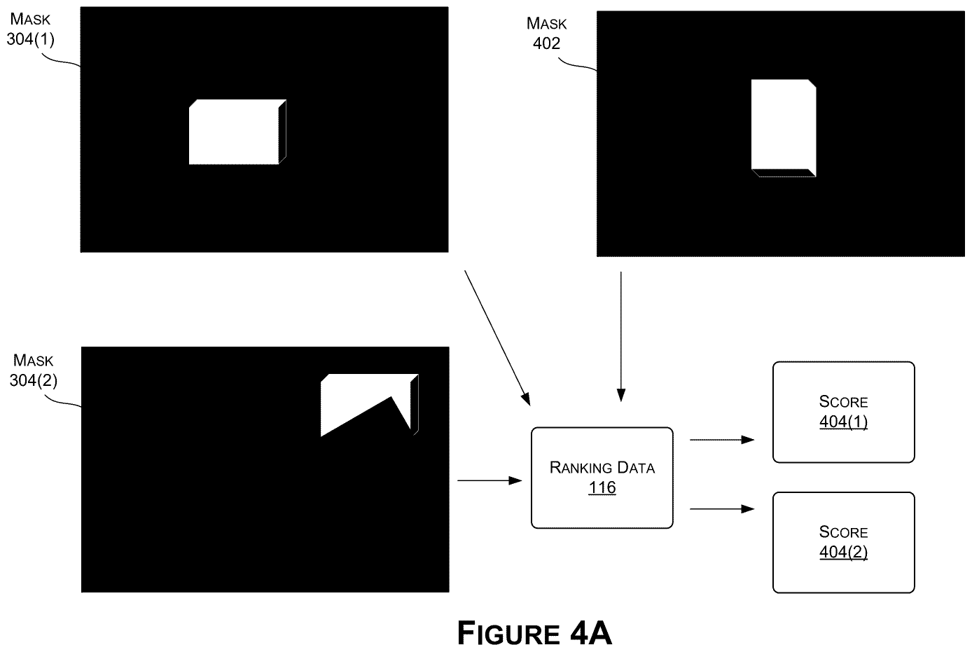

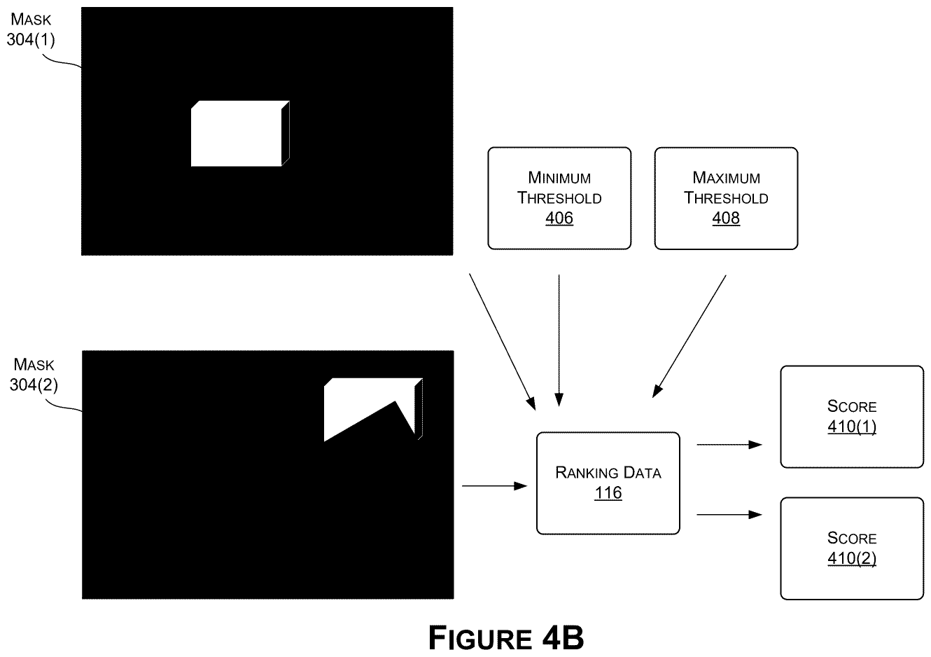

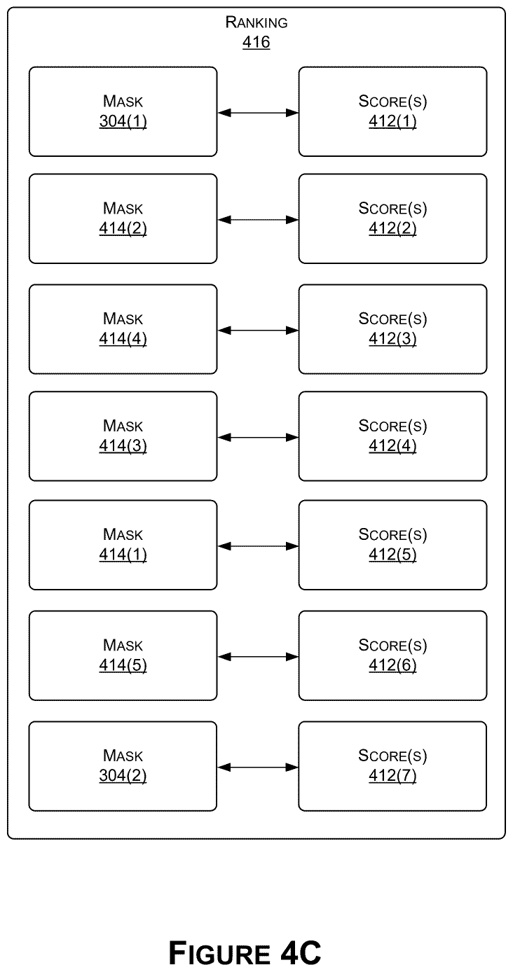

For more details, FIGS. 4A-4C illustrate an example of ranking segmentation masks associated with objects, in accordance with some embodiments of the present disclosure. As shown by the example of FIG. 4A, the ranking component(s) 114 may analyze the first segmentation mask 304(1) associated with the first object 204(1) with respect to a reference segmentation mask 402 associated with the objects 204. In some examples, the reference segmentation mask 402 is associated with the object 204 including a standard position and/or a standard orientation. For instance, the reference segmentation mask 402 may represent how a segmentation mask associated with the object 204 should appear if the object is not occluded within the image 302. Based at least on the analysis, the ranking component(s) 114 may determine a first score 404(1) associated with the first segmentation mask 304(1). As described herein, in some examples, the ranking component(s) 114 may use one or more techniques to determine the first score 404(1), such as Hu-Moment distances. For example, the ranking component(s) 114 may determine a first value (e.g., a first Hu-Moment value) associated with the first segmentation mask 304(1), a second value (e.g., a second Hu-Moment value) associated with the reference segmentation mask 402, and then the first score 404(1) as the difference between the values.

Additionally, the ranking component(s) 114 may analyze the second segmentation mask 304(2) associated with the second object 204(2) with respect to the reference segmentation mask 402 associated with the objects 204. Based at least on the analysis, the ranking component(s) 114 may determine a second score 404(2) associated with the second segmentation mask 304(2) using one or more similar techniques as used to determine the first score 404(1). As described herein, in some examples, this type of scoring of the segmentation masks 304(1)-(2) may be associated with similarities between the segmentation masks 304(1)-(2) and the reference segmentation mask 402. As such, and in the example of FIG. 4A, the first score 404(1) associated with the first segmentation mask 304(1) may be greater than the second score 404(2) associated with the second segmentation mask 304(2). This is because, in some examples, the image 302 represents the first object 204(1) as not being occluded by one or more other objects 204(2)-(7) while also representing the second object 204(2) as being occluded by at least the fourth object 204(4). As such, and as described in more detail herein, when selecting the objects 204 for interaction, the first object 204(1) may include a better selection for interaction as compared to the second object 204(2).

Next, and as shown by the example of FIG. 4B, the ranking component(s) 114 may analyze the first segmentation mask 304(1) associated with the first object 204(1) with respect to a minimum threshold area 406 and a maximum threshold area 408. Based at least on the analysis, the ranking component(s) 114 may determine a first score 410(1) associated with the first segmentation mask 304(1). Additionally, the ranking component(s) 114 may analyze the second segmentation mask 304(2) with respect to the minimum threshold area 406 and the maximum threshold area 408. Based at least on the analysis, the ranking component(s) 114 may determine a second score 410(2) associated with the second segmentation mask 304(2). As described herein, the scores 410(1)-(2) may be associated with penalizing the segmentation masks 304(1)-(2) if the segmentation masks 304(1)-(2) are outside of the range associated with the minimum threshold area 406 and the maximum threshold area 408.

For example, if the area of the first segmentation mask 304(1) is less than the minimum threshold area 406, then the first score 304(1) may be greater than zero. For example, the ranking component(s) 114 may determine that the first score 410(1) includes the area of the first segmentation mask 304(1) minus the minimum threshold area 406 multiplied by a ratio. Additionally, if the area of the first segmentation mask 304(1) is between the minimum threshold area 406 and the maximum threshold area 408, then the first score 304(1) may include zero. Furthermore, if the area of the first segmentation mask 304(1) is greater than the maximum threshold area 408, then the first score 304(1) may again be greater than zero. For example, the ranking component(s) 114 may determine that the first score 410(1) includes the maximum threshold area 408 minus the area of the first segmentation mask 304(1) multiplied by the ratio. While this is just one example technique for how the ranking component(s) 114 may determine the first score 410(1) using the minimum threshold area 406 and the maximum threshold area 408, in other examples, the ranking component(s) 114 may use additional and/or alternative techniques.

Next, and as shown by the example of FIG. 4C, the ranking component(s) 114 may determine final scores 412(1)-(2) respectively associated with the segmentation masks 304(1)-(2) using the scores 404(1)-(2) and the scores 410(1)-(2). For instance, in some examples, the ranking component(s) 114 may determine the final scores 412(1)-(2) by subtracting the scores 410(1)-(2) from the scores 404(1)-(2) (and/or using any other technique). Additionally, the ranking component(s) 114 may perform similar processes to determine final scores 412(3)-(7) associated with additional segmentation masks 414(1)-(5) respectively associated with the objects 204(3)-(7). The ranking component(s) 114 may then determine a ranking 416 for the segmentation masks 304(1)-(2) and 414(1)-(5) using the final scores 412(1)-(7). For example, the ranking 416 may rank the segmentation masks 304(1)-(2) and 414(1)-(5) starting with the highest final score 412(1) and moving in descending order.

Referring back to the example of FIG. 1, the process 100 may include the perception component(s) 108 using one or more selection components 118 to select at least an object based on the ranking, where the selection of the object may be represented by selection data 120. For instance, in some examples, the selection component(s) 118 may select the object that is associated with the highest ranking. For instance, and in the example of FIG. 4C, the selection component(s) 118 may select the first object 204(1) based on the first segmentation mask 304(1) including the highest ranking from among the segmentation masks 304(1)-(2) and 414(1)-(5). In other words, the selection component(s) 118 may select the first object 204(1) based at least on the first object 204(1) including the easiest of the objects 204 to interact with within the container 202.

The process 100 may then include the perception component(s) 108 using one or more pose-estimation components 122 to determine a pose associated with the selected object. As described herein, in some examples, the pose may include at least a location (e.g., the x-coordinate location, the y-coordinate location, and the z-coordinate location) and an orientation (e.g., the roll, the pitch, and the yaw) of the object. Additionally, the pose-estimation component(s) 122 may use one or more techniques to determine the pose associated with the object. For instance, in some examples, the pose-estimation component(s) 122 may initially determine a coarse pose associated with the object using one or more machine learning models. For example, the machine learning model(s) may process input data representing at least the image(s), one or more depth images associated with the objects and/or the container (and/or other types of depth information), the segmentation mask associated with the object, and a three-dimensional (3D) mesh of the object and, based at least on the processing, output data representing the coarse pose. The pose-estimation component(s) 122 may then refine the coarse pose to determine a final pose associated with the object. For instance, the pose-estimation component(s) 122 may determine the final pose using the coarse pose (e.g., a first point cloud associated with the coarse pose), the 3D mesh of the object (e.g., a second point cloud associated with the 3D mesh), and one or more algorithms (e.g., one or more iterative closest point algorithms).

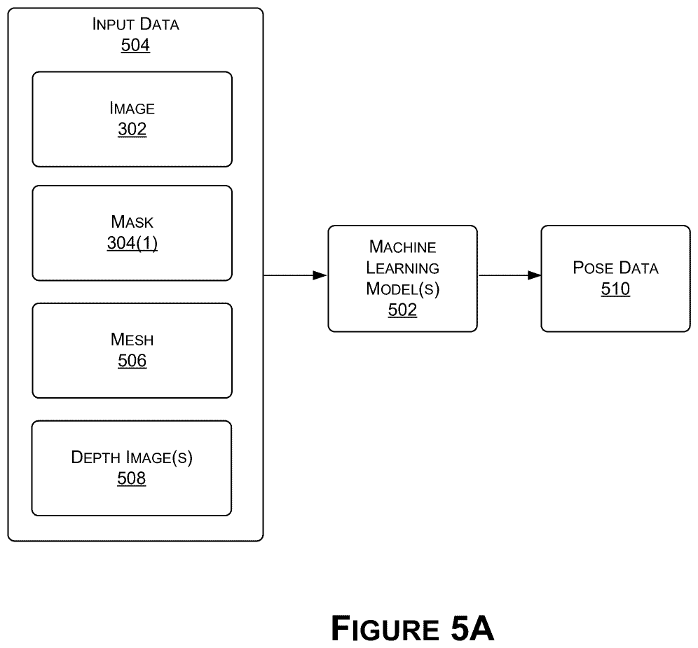

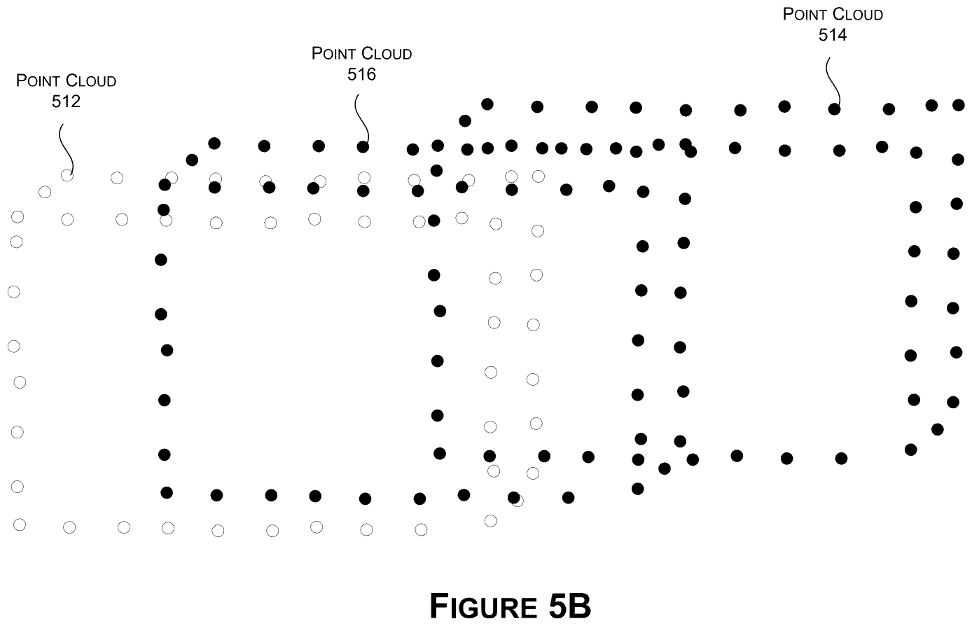

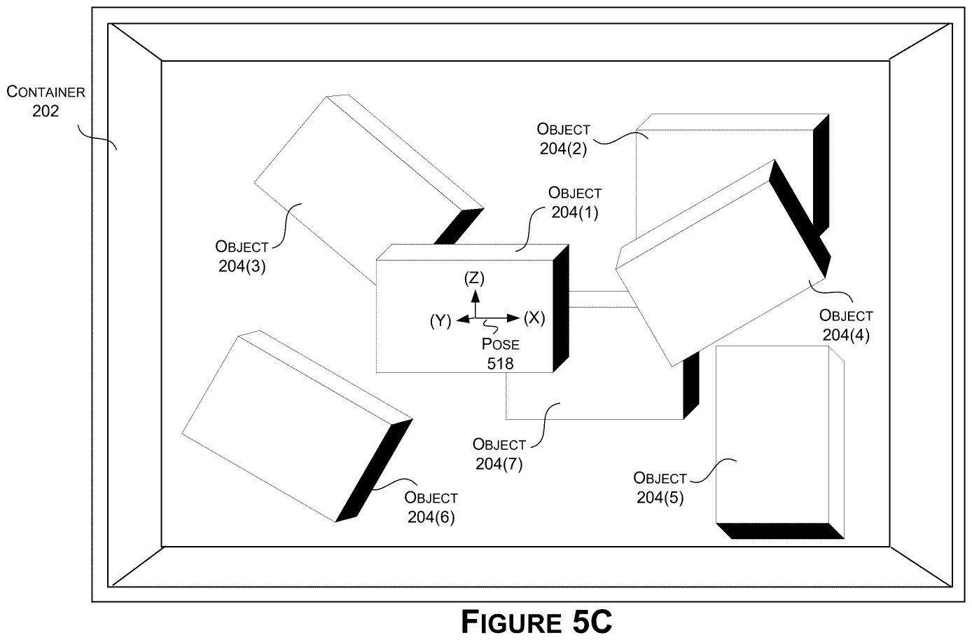

For more details, FIGS. 5A-5C illustrate an example of determining a pose associated with an object, in accordance with some embodiments of the present disclosure. As shown by the example of FIG. 5A, to determine a coarse pose associated with the first object 204(1), the pose-estimation component(s) 122 may input, into one or more machine learning models 502, input data 504 representing at least the image 302 of the objects 204, the first segmentation mask 304(1) associated with the first object 204(1), a 3D mesh 506 associated with the first object 204(1), and/or one or more depth images 508 associated with the objects 204. In some examples, the 3D mesh 506 may represent dimensions of the object 204, a standard pose associated with the object 204, and/or additional information associated with the object 204. Based at least on processing the input data 504, the machine learning model(s) 502 may generate and/or output pose data 510 representing the coarse pose associated with the first object 204(1).

Next, and as shown by the example of FIG. 5B, the pose-estimation component(s) 122 may use one or more techniques to refine the coarse pose in order to determine a final pose associated with the first object 204(1). For instance, in some examples, the pose-estimation component(s) 122 may use one or more algorithms, such as one or more iterative closest point algorithms, to refine the coarse pose in order to determine the final pose. For example, and as shown, the pose-estimation component(s) 122 may use the 3D mesh and the coarse pose to determine a first point cloud 512 associated with the first object 204(1), such as by projecting the 3D mesh by the coarse pose to get the first point cloud 512. Additionally, the pose-estimation component(s) 122 may use depth information—such as the depth image(s), LiDAR data, RADAR data, and/or the like—to determine a second point cloud 514 associated with the first object 204(1). The pose-estimation component(s) 122 may then use the first point cloud 512 and the second point cloud 514 to determine a third point cloud 516 that represents the final pose associated with the first object 204(1). For instance, in some examples, the pose-estimation component(s) 122 may use one or more fine matching techniques—such as one or more iterative closest point algorithms and/or any other type of algorithm—to determine the third point cloud 516 using the first point cloud 512 and the second point cloud 514.

As shown by the example of FIG. 5C, based at least on performing one or more of these processes, the pose-estimation component(s) 122 may determine a final pose 518 associated with the first object 204(1). As described herein, the final pose 518 may indicate the location of the first object 204(1), such as the x-coordinate location, the y-coordinate location and/or the z-coordinate location, and/or the orientation of the first object 204(1), such as the roll, the pitch, and/or the yaw.

Referring back to the example of FIG. 1, while the examples herein describe the pose-estimation component(s) 122 determining the coarse pose and then refining the coarse pose to determine the final pose, in other examples, the pose-estimation component(s) 122 may use the coarse pose as the final pose associated with the object. Additionally, while the examples herein describe specific techniques for determining the coarse pose and/or the final pose, in other examples, the pose-estimation component(s) 122 may use any other technique to determine the coarse pose and/or the final pose. In any of these examples, the pose-estimation component(s) 122 may then generate and/or output pose data 124 representing the final pose associated with the object.

The process 100 may then include using one or more planning components 126 to determine motion associated with the machine 106 that causes the machine to interact with the object. As described herein, in some examples, the interaction with the object may include the machine 106 using a manipulator to grab the object within the container and then remove the object from the container. However, in other examples, the interaction associated with the object may include any other type of interaction, such as touching the object, pushing the object, pulling the object, attaching another object (e.g., a label) to the object, and/or the like. Additionally, the planning component(s) 126 may use at least the pose data 124 associated with the object to determine the motion.

For instance, the process 100 may include the planning component(s) 126 using one or more grasping components 128 to determine one or more grasp types associated with interacting with the object. As described herein, the grasping component(s) 128 may determine the grasp type(s) using the pose associated with the object, where the grasp type is associated with at least an axis and a translation along the axis. The grasping component(s) 128 may then rank the grasp type(s) based at least on the axes of the individual grasp type(s), the translations along the axes, and a reference vector, such as the up vector (and/or any other vector). For example, and when there are multiple grasp types, the grasping component(s) 128 may rank the grasp types based on dot products between the axes of the grasp types and the up vector. In such an example, a grasp type that includes an axis that is closer to the up vector may be ranked higher than a grasp type that includes an axis that is farther from the up vector.

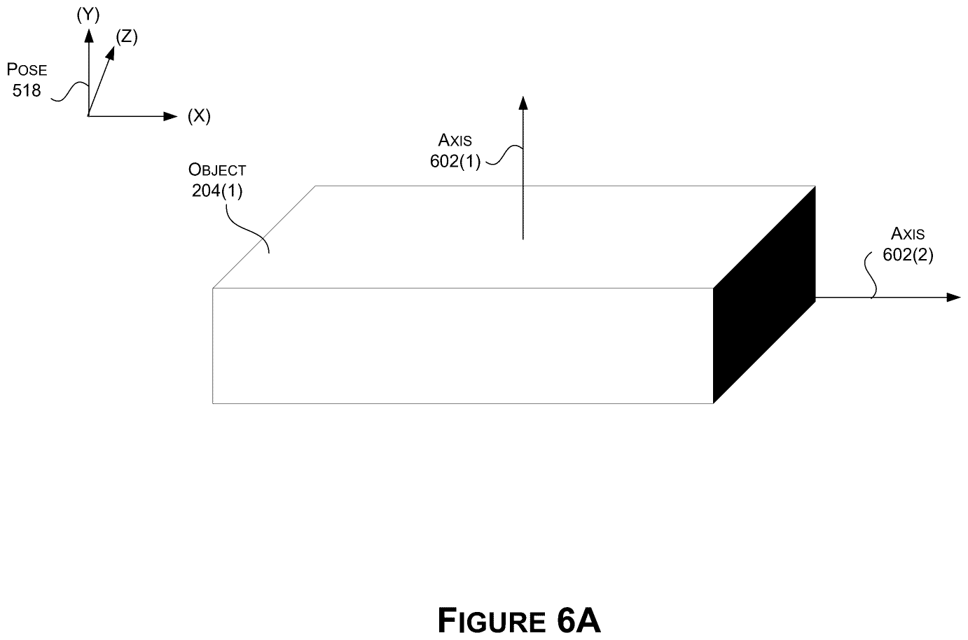

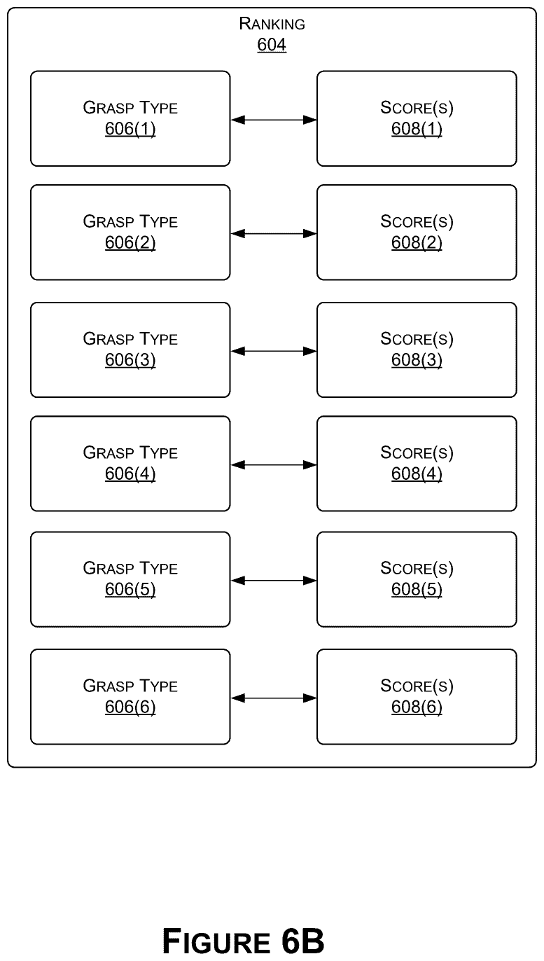

For more details, FIGS. 6A-6B illustrate an example of ranking different grasp types associated with an object, in accordance with some embodiments of the present disclosure. As shown by the example of FIG. 6A, the grasping component(s) 128 may determine that the first object 204(1) (as well as the other objects 204(2)-(7)) is associated with multiple grasp types, such as a first grasp type associated with a first axis 602(1) and a second grasp type associated with a second axis 602(2). For instance, the machine may be capable to interacting with the first object 204(1) by at least attaching to a first surface of the first object 204(1) that is associated with the first axis 602(1) and a second surface of the first object 204(1) that is associated with the second axis 602(2). While the example of FIG. 6A only illustrates the two different grasp types, in other examples, the first object 204(1) (as well as the other objects 204(2)-(7)) may be associated with any number of grasp types. For example, the first object 204(1) may be associated with six grasp types that correspond to each surface of the first object 204(1).

Next, and as shown by the example of FIG. 6B, the grasping component(s) 128 may determine a ranking 604 for grasp types 606(1)-(6) (also referred to singularly as “grasp type 606” or in plural as “grasp types 606”) using one or more techniques. For instance, the grasping component(s) 128 may determine scores 608(1)-(6) (also referred to singularly as “score 608” or in plural as “scores 608”) respectively associated with the grasp types 606 based on taking dot products between the axes associated with the grasp types 606 and the up vector. For example, the greater the dot product, the greater the score 608 associated with a grasp type 606 and the lower the dot product, the lower the score 608 associated with a grasp type 606. The grasping component(s) 128 may then rank the grasp types 606 from the highest score 608 and in descending order. In other words, the grasping component(s) 128 may rank the grasp types 606 such that the grasp type 606 that is associated with an axis closest to the up vector is ranked first, followed by the grasp type 606 that is associated with an axis that is next closest to the up vector, and/or so forth.

While the examples herein describe using the up vector to rank grasp types, in other examples, any other vector may be used to rank grasp types. For instance, the vector used to rank grasp types may depend on one or more factors, such as the container for which the objects are located. For example, the vector may be associated with an angle that is in a direction of an opening of a container such that the vector points in an easiest direction for removing objects from the container.

Referring back to the example of FIG. 1, the process 100 may include the planning component(s) 126 using one or more collision components 130 to determine whether one or more motion paths associated with one or more of the grasp types satisfy a collision-check. As described herein, in some examples, a motion path may satisfy a collision-check when the machine 106 does not collide with the container or one or more other objects when performing the motion and not satisfy the collision-check when the machine 106 collides with the container and/or another object when performing the motion. Additionally, in some examples, the collision component(s) 130 may analyze each motion path associated with each grasp type using the collision-check. However, in other examples, the collision component(s) 130 may analyze one or more specific motion paths associated with one or more specific grasp types using the collision-check.

For example, the collision component(s) 130 may analyze a first motion path that is associated with a highest ranking grasp type. If the collision component(s) 130 determines that the first motion path satisfies the collision-check, then the collision component(s) 130 may select the first motion path for further processing. However, if the collision component(s) 130 determines that the first motion path does not satisfy the collision-check, then the collision component(s) 130 may analyze a second motion path that is associated with a second highest ranking grasp type. Again, if the collision component(s) 130 determines that the second motion path satisfies the collision-check, then the collision component(s) 130 may select the second motion path for further processing. However, if the collision component(s) 130 determines that the second motion path does not satisfy the collision-check, then the collision component(s) 130 may analyze a third motion path that is associated with a third highest ranking grasp type. This process may then continue to repeat until the collision component(s) 130 identifies a motion path that satisfies the collision-check and/or until the collision component(s) 130 analyzes all of the motion paths.

The collision component(s) 130 may use one or more techniques to perform a collision-check associated with a motion path. For instance, the collision component(s) 130 may determine one or more poses of the machine 106 (e.g., the manipulator) while navigating along the motion path to grab the object. In some examples, the pose(s) may include at least a pre-grasp pose that is associated with the machine 106 moving towards the object and a target pose that is associated with the machine 106 interacting with (e.g., grabbing) the object. In such examples, the pre-grasp pose may be determined based on moving in a normal direction from a surface associated with the grasp type and away from the object by a threshold distance (e.g., 0.3 meters). The collision component(s) 130 may then use one or more collision techniques—such as RRT, Lula RRT, cuRobo, Edge Collision Detection, Circle Point Collision, Rectangle Point Collision, and/or any other collision detection technique—to determine whether there is a collision associated with the pose(s). If the collision component(s) 130 determines that there is no collision associated with the pose(s), then the collision component(s) 130 may determine that the motion path satisfies the collision-check. However, if the collision component(s) 130 determines that there is a collision associated with at least one of the pose(s), then the collision component(s) 130 may determine that the motion path does not satisfy the collision-check.

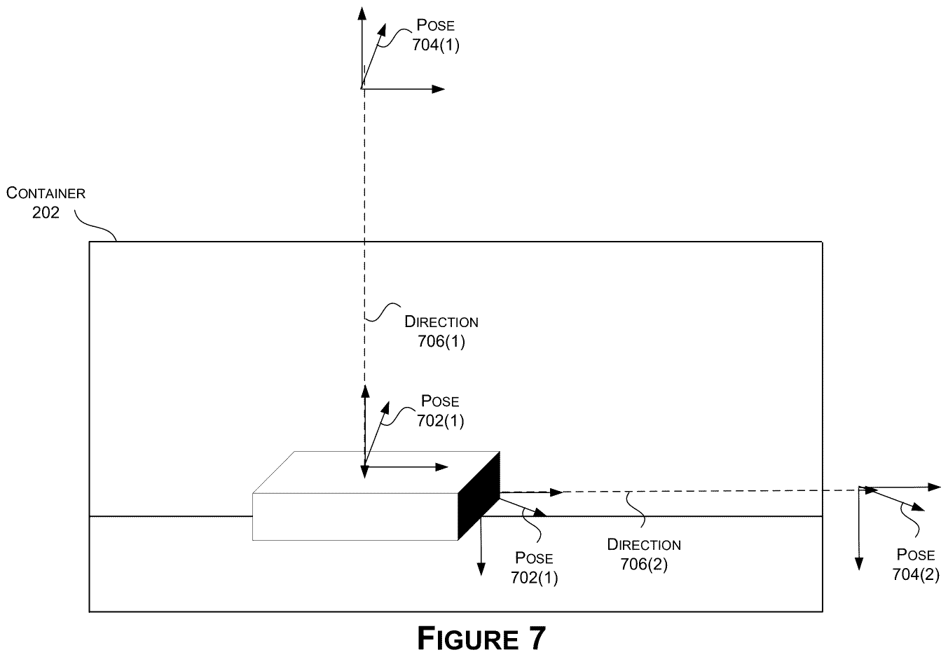

For more details, FIG. 7 illustrates an example of performing a collision-check associated with motion paths for interacting with an object, in accordance with some embodiments of the present disclosure. As shown, the collision component(s) 130 may determine at least a first target pose 702(1) associated with the first grasp type from the example of FIG. 6A. The collision component(s) 130 may also determine a first pre-grasp pose 704(1) by moving in a first direction 706(1) that is perpendicular to the first surface associated with the first grasp type and by a threshold distance. Additionally, the collision component(s) 130 may then use one or more collision techniques to determine that there is no collision associated with the first target pose 702(1) and the first pre-grasp pose 704(1). As such, the collision component(s) 130 may determine that the first motion path satisfies the collision-check.

Additionally, the collision component(s) 130 may determine at least a second target pose 702(2) associated with the second grasp type from the example of FIG. 6A. The collision component(s) 130 may also determine a second pre-grasp pose 704(2) by moving in a second direction 706(2) that is perpendicular to the second surface associated with the second grasp type and by a threshold distance. Additionally, the collision component(s) 130 may then use one or more collision techniques to determine that there is a collision associated with at least the second pre-grasp pose 704(2). As such, the collision component(s) 130 may determine that the second motion path does not satisfy the collision-check. In some examples, the collision component(s) 130 may then perform similar processes for one or more additional motion paths associated with one or more additional grasp types associated with the first object 204(1).

Referring back to the example of FIG. 1, if the collision component(s) 130 determines that all of the motion path(s) associated with the object do not satisfy the collision-check, then the process 100 may include registering the segmentation mask and/or the object as failed (which is indicated by the arrow from the collision component(s) 130 to the perception component(s) 108. For instance, the process 100 may include the collision component(s) 130 adding the failed segmentation mask and/or the failed object to a list. Additionally, the process 100 may include the perception component(s) 108 performing one or more of the processes described herein to select a new object for interaction.

For example, the segmentation component(s) 110 may again process the sensor data 104 to generate the segmentation data 112 representing the segmentation masks associated with the objects. The ranking component(s) 114 may then process the segmentation data 112 to rank the segmentation masks. However, the ranking component(s) 114 may also use one or more techniques to determine if at least one of the segmentation masks is associated with at least one failed segmentation mask that is included in the list. For example, and for a failed segmentation mask included in the list, the ranking component(s) 114 may compare the segmentation masks to the failed segmentation mask to determine amounts of overlap between the segmentation mask and the failed segmentation mask. The ranking component(s) 114 may then determine whether one or more of the amounts of overlap satisfy a threshold amount of overlap (e.g., 90%, 95%, etc.). If the ranking component(s) 114 determine that an amount of overlap associated with a segmentation mask satisfies (e.g., is equal to or greater than) the threshold amount of overlap, the ranking component(s) 114 may determine that the segmentation mask corresponds to the failed segmentation mask.

The ranking component(s) 114 may then perform one or more processes to ensure that the selection component(s) 118 does not again select the determined segmentation mask. For example, the ranking component(s) 114 may remove the determined segmentation mask from the rankings and/or cause the determined segmentation mask to be lower in the rankings. This way, the perception component(s) 108 does not again select a failed segmentation mask for further processing by the planning component(s) 126.

This process 100 may continue to repeat until the collision component(s) 130 determines a motion path associated with a grasp type that satisfies the collision-check. The process 100 may then include the planning component(s) 126 using one or more motion components 132 to generate motion data 134 for causing the machine 106 to perform one or more operations associated with interacting with the object. As described herein, the motion component(s) 132 may include, but is not limited to, one or more machine learning models, one or more neural networks, one or more algorithms, one or more modules, and/or any other type of processing component that is configured to perform one or more of the processes described herein.

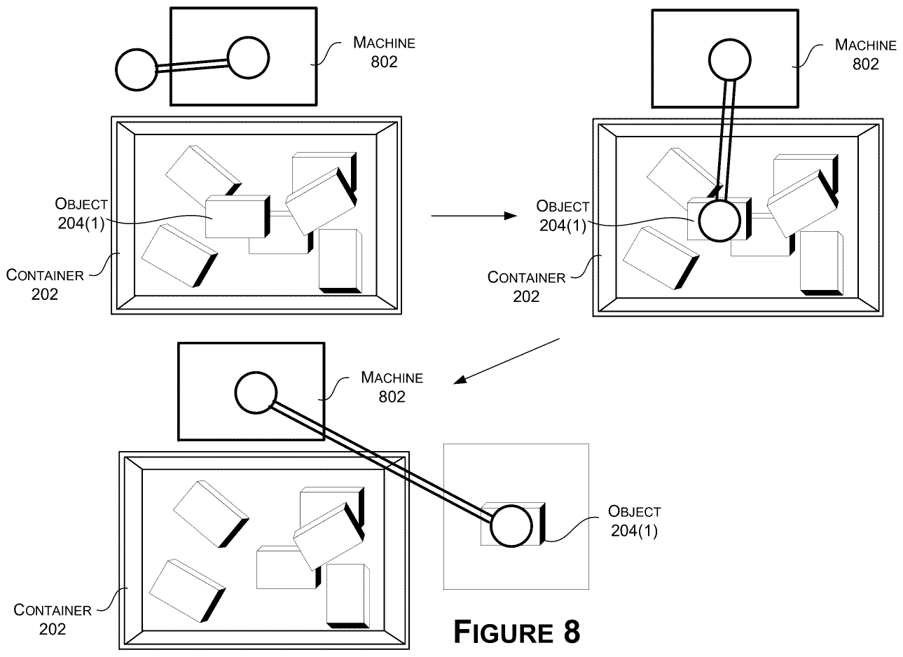

For instance, FIG. 8 illustrates an example of causing a machine to perform one or more operations for interacting with objects located within a container, in accordance with some embodiments of the present disclosure. As shown, at a first time instance shown by the top-left illustration, a machine 802 may include a manipulator that is located at least partially outside of the container 202. Next, at a second time instance shown by the top-right illustration, the motion component(s) 132 may then generate motion data that causes the machine 802 to move the manipulator along a trajectory in order to interact with the first object 204(1) within the container 202. For instance, and in the example of FIG. 8, the interaction may include grabbing the first object 204(1). As such, at a third time instance shown by the bottom-left illustration, the motion data may further cause the machine 802 to move the manipulator to place the first object 204(1) outside of the container 202.

Referring back to the example of FIG. 1, in some examples, the process 100 may then continue to repeat in order for the machine 106 to interact with additional objects associated with the container. For example, if the interactions again include removing the objects from the container, the process 100 may continue in order to continue removing the objects from the container. In some examples, with each new iteration of the process 100 after interacting with an item, the process 100 may include removing the failed objects and/or failed segmentation masks from the list such that the new iteration is able to interact with any of the objects still associated with the container.

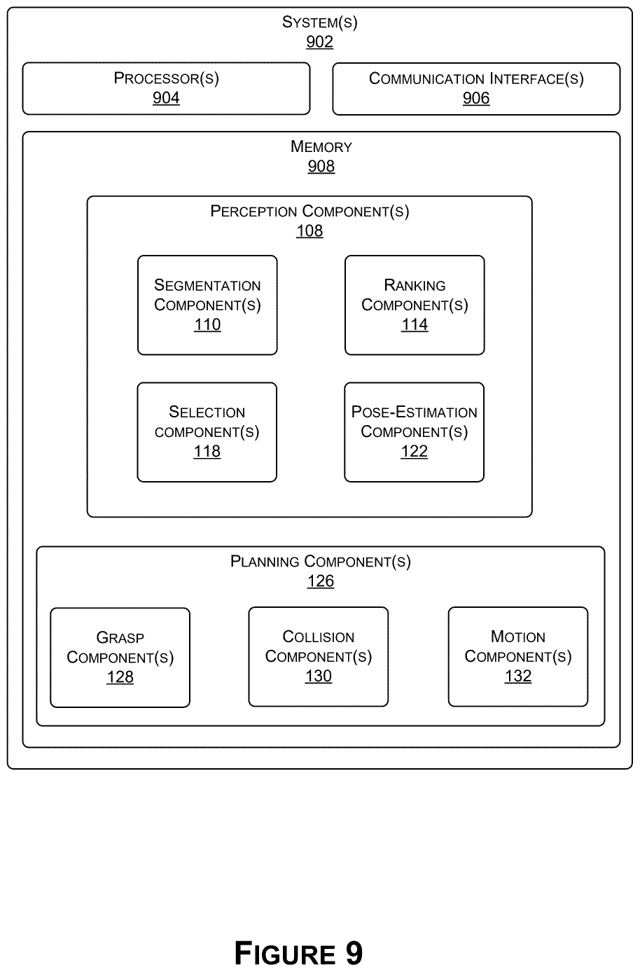

FIG. 9 illustrates an example of one or more systems that are configured to perform at least a portion of the processes described herein, in accordance with some embodiments of the present disclosure. In some examples, the system(s) 902 may be included as part of a machine, such as the machine 106 and/or an example autonomous vehicle 1300. In some examples, the system(s) 902 may be remote from and/or communicate with the machine. For example, the system(s) 902 may receive sensor data from the machine, perform one or more of the processes described herein to generate motion data for controlling the machine, and then send the motion data to the machine.

As shown, the system(s) 902 may include one or more processors 904 (which may include, and/or be similar to, a CPU(s) 1306, a GPU(s) 1308, a processor(s) 1310, a CPU(s) 1318, a GPU(s) 1320, a CPU(s) 1406, and/or a GPU(s) 1408), one or more communication interfaces 906 (which may include, and/or be similar to, a network interface 1324 and/or a communication interface 1410), and a memory 908 (which may include, and/or be similar to, a memory 1404). Additionally, the memory 908 may store the perception component(s) 108, the segmentation component(s) 110, the ranking component(s) 114, the selection component(s) 118, the pose-estimation component(s) 122, the planning component(s) 126, the grasp component(s) 128, the collision component(s) 130, and/or the motion component(s) 132. Furthermore, the processor(s) 904 may execute the perception component(s) 108, the segmentation component(s) 110, the ranking component(s) 114, the selection component(s) 118, the pose-estimation component(s) 122, the planning component(s) 126, the grasp component(s) 128, the collision component(s) 130, and/or the motion component(s) 132 to perform one or more of the processes described herein.

While the example of FIG. 9 illustrates the components as including software stored in the memory 902, in other examples, the components may include any other type of processing components. For example, a component may include, but is not limited to, one or more machine learning models, one or more neural networks, one or more modules, one or more algorithms, one or more classifiers, one or more applications, software, hardware, code, and/or the like.

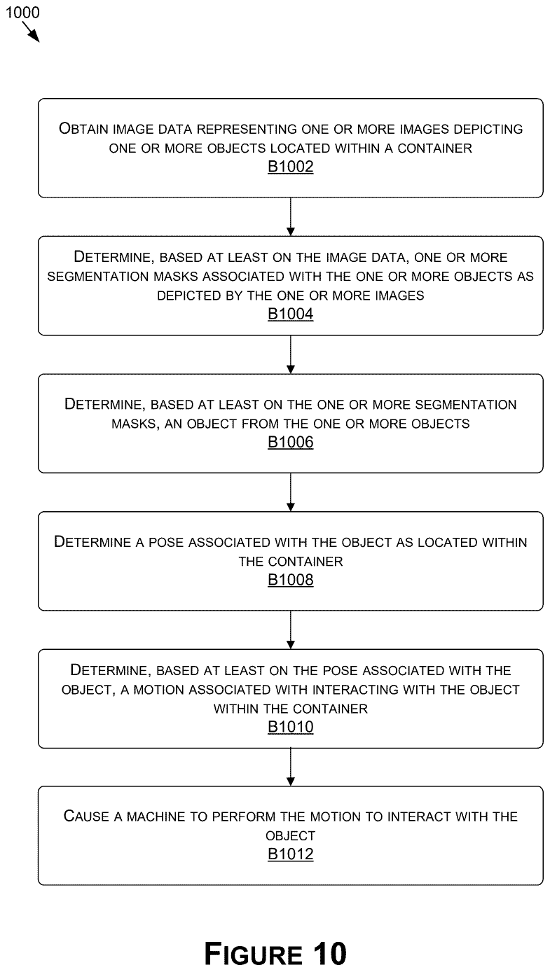

Now referring to FIGS. 10-12, each block of method 1000, 1100, and 1200 described herein, comprises a computing process that may be performed using any combination of hardware, firmware, and/or software. For instance, various functions may be carried out by a processor executing instructions stored in memory. The methods 1000, 1100, and 1200 may also be embodied as computer-usable instructions stored on computer storage media. The methods 1000, 1100, and 1200 may be provided by a standalone application, a service or hosted service (standalone or in combination with another hosted service), or a plug-in to another product, to name a few. In addition, these methods 1000, 1100, and 1200 described, by way of example, with respect to FIG. 1. However, these methods 1000, 1100, and 1200 may additionally or alternatively be executed by any one system, or any combination of systems, including, but not limited to, those described herein.

FIG. 10 illustrates a flow diagram showing a method 1000 for using sensor data segmentation to interact with an object located within a container, in accordance with some embodiments of the present disclosure. The method 1000, at block B1002, may include obtaining image data representing one or more images depicting one or more objects located within a container and the method 1000, at block B1004, may include determining, based at least on the image data, one or more segmentation masks associated with the one or more objects as depicted by the one or more images. For instance, the perception component(s) 108 may receive the image data (e.g., the sensor data 104) representing the image(s) depicting the object(s) located within the container. As described herein, the image data may be obtained using the sensor(s) 102 of the machine 106. The perception component(s) 108 (e.g., the segmentation component(s) 110) may then perform one or more segmentation techniques to determine the segmentation mask(s) associated with the object(s).

The method 1000, at block B1006, may include determining, based at least on the one or more segmentation masks, an object from the one or more objects. For instance, the perception component(s) 108 (e.g., the ranking component(s) 114) may use one or more of the techniques described herein to determine one or more scores associated with the segmentation mask(s). The perception component(s) 108 may then use the score(s) to rank the segmentation mask(s). Additionally, the perception component(s) 108 (e.g., the selection component(s) 118) may use the ranking to select the object from the object(s). In some examples, the perception component(s) 108 may select the object based at least on the object being associated with the highest ranked segmentation mask.

The method 1000, at block B1008, may include determining a pose associated with the object as located within the container. For instance, the perception component(s) 108 (e.g., the pose-estimation component(s) 122) may determine the pose associated with the object. As described herein, in some examples, the perception component(s) 108 may perform a first technique to determine a coarse pose associated with the object and then perform a second technique to refine the coarse pose to determine a final pose associated with the object. Additionally, the pose may include a location (e.g., the x-coordinate location, the y-coordinate location, and/or the z-coordinate location) and/or an orientation (e.g., the roll, the pitch, and/or the yaw) of the object.

The method 1000, at block B1010, may include determining, based at least on the pose associated with the object, a motion associated with interacting with the object within the container. For instance, the planning component(s) 126 (e.g., the grasping component(s) 128) may initially determine at least a grasp type associated with interacting with the object. The planning component(s) 126 (e.g., the collision component(s) 130) may then determine that the motion associated with the grasp type satisfies a collision-check. Additionally, based at least on the motion satisfying the collision-check, the planning component(s) 126 (e.g., the motion component(s) 132) may generate the motion data 134 that causes the machine 106 to perform the motion to interact with the object.

The method 1000, at block B1012, may include causing a machine to perform the motion to interact with the object. For instance, the planning component(s) 126 may provide the motion data 134 to the machine 106 in order to cause the machine 106 to interact with the object. As described herein, in some examples, the interaction may be associated with the machine 106 picking the object up from the container in order to remove the object from the container. However, in other examples, the interaction may include any other type of interaction between the machine 106 and the object.

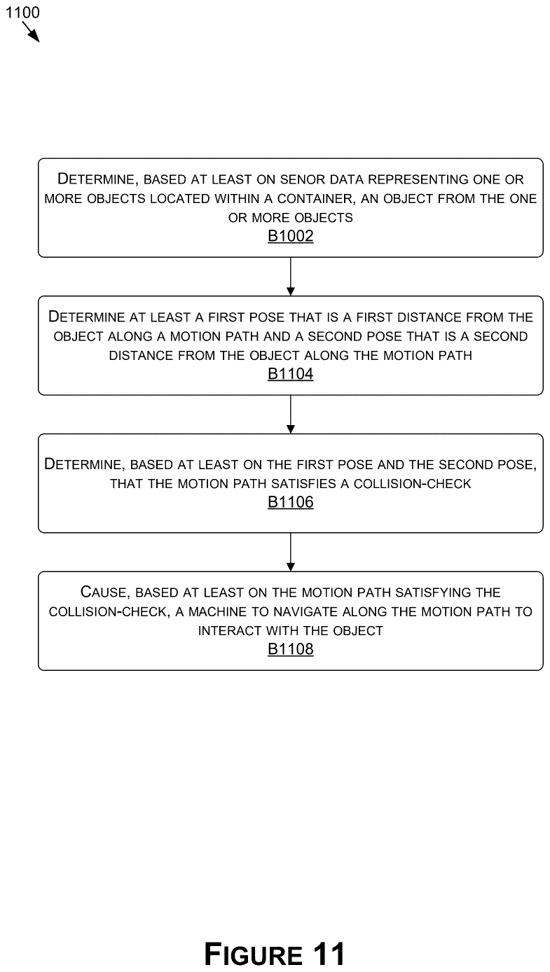

FIG. 11 illustrates a flow diagram showing a method 1100 for using multiple poses to perform a collision-check when controlling a machine, in accordance with some embodiments of the present disclosure. The method 1100, at block B1102, may include determining, based at least on sensor data representing one or more objects located within a container, an object from the one or more objects. For instance, the perception component(s) 108 may obtain the sensor data 104 obtained using the sensor(s) 102, where the sensor data 104 represents the object(s) located within the container. The perception component(s) 108 may then perform one or more of the techniques described herein to determine the object based at least on the sensor data 104. For example, the perception component(s) 108 may use the sensor data 104 to generate one or more segmentation masks associated with the object(s) and then use the segmentation mask(s) to determine the object.

The method 1100, at block B1104, may include determining at least a first pose that is a first distance from the object along a motion path and a second pose that is a second distance from the object along the motion path. For instance, the planning component(s) 126 (e.g., the collision component(s) 130) may determine at least the first pose and the second pose associated with the motion path. As described herein, in some examples, the first pose may include a pre-grasp pose and the second pose may include a grasp pose associated with the object. Additionally, in some examples, the second pose may be associated with the machine 106 interacting with a surface of the object and the first pose may be associated with a threshold distance along an approach direction that is perpendicular to the surface.

The method 1100, at block B1106, may include determining, based at least on the first pose and the second pose, that the motion path satisfies a collision-check. For instance, the planning component(s) 126 (e.g., the collision component(s) 130) may use the first pose and the second pose to determine that the motion path satisfies the collision-check. In some examples, the planning component(s) 126 may make the determination based on determining that the machine 106 does not collide with the container and/or one or more other objects when in the first pose and the second pose.

The method 1100, at block B1108, may include causing, based at least on the motion path satisfying the collision-check, a machine to navigate along the motion path to interact with the object. For instance, the planning component(s) 126 (e.g., the motion component(s) 132) may generate the motion data 134 that causes the machine 106 to navigate according to the motion path. The planning component(s) 126 may then provide the motion data 134 to the machine 106 in order to cause the machine 106 to interact with the object using the motion path.

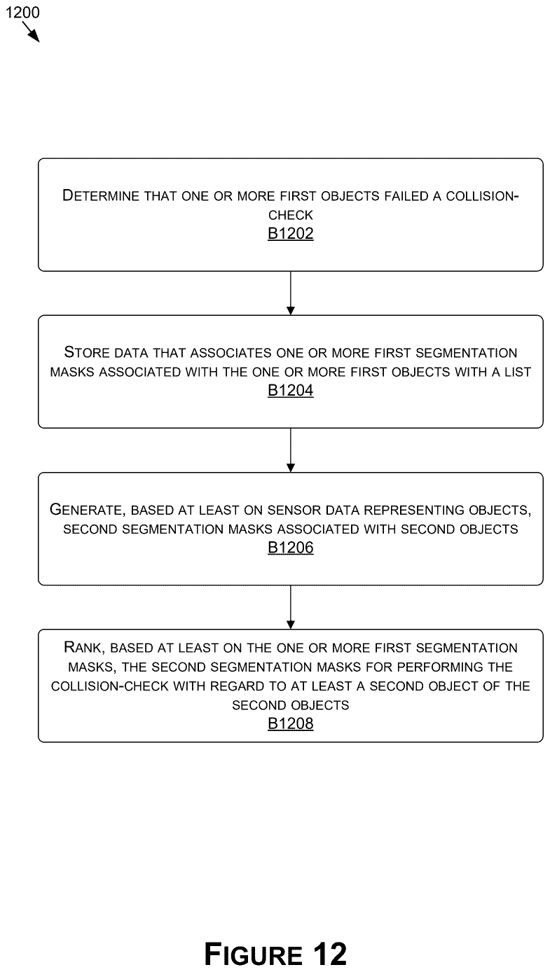

FIG. 12 illustrates a flow diagram showing a method 1200 for using a failed mask list to rank segmentation masks for performing a collision-check, in accordance with some embodiments of the present disclosure. The method 1200, at block B1202, may include determining that one or more first objects failed a collision-check. For instance, the planning component(s) 126 (e.g., the collision component(s) 130) may perform the collision-check with regard to the first object(s). During the collision-check, the planning component(s) 126 may determine that there is a collision with respect to at least one of a container or more or more other objects located within the container. As such, the planning component(s) 126 may determine that the first object(s) failed the collision-check.

The method 1200, at block B1204, may include storing data that associates one or more first segmentation masks associated with the first objects or more first objects with a list. For instance, the planning component(s) 126 (e.g., the collision component(s) 130) may add the first object(s) to the list based at least on the first object(s) failing the collision-check. In some examples, adding the first object(s) may include at least storing data representing the first segmentation mask(s) associated with the first object(s).

The method 1200, at block B1206, may include generating, based at least on sensor data representing second objects, second segmentation masks associated with the second objects. For instance, the perception component(s) 108 (e.g., the segmentation component(s) 110) may process the sensor data 104 to generate the second segmentation masks associated with the second objects. As described herein, in some examples, the second objects may include at least some of the first object(s).

The method 1200, at block B1208, may include ranking, based at least on the one or more first segmentation masks, the second segmentation masks for performing the collision-check with regard to at least a second object of the second objects. For instance, the perception component(s) 108 (e.g., the ranking component(s) 114) may rank the second segmentation masks associated with the second objects using one or more of the processes described herein. Additionally, when performing the ranking, the perception component(s) 108 may use the list that is associated with the first segmentation mask(s). For instance, the perception component(s) 108 may determine whether one or more of the second segmentation masks include at least one of the first segmentation mask(s). If the perception component(s) 108 determines that a second segmentation mask includes a first segmentation mask, then the perception component(s) 108 may determine a lower ranking for the second segmentation mask. This is because the second segmentation mask is likely associated with an object that has already failed the collision-check and should not be selected again until the machine 106 interacts with at least one other object within the container.

### Example Autonomous Vehicle

FIG. 13A is an illustration of an example autonomous vehicle 1300, in accordance with some embodiments of the present disclosure. The autonomous vehicle 1300 (alternatively referred to herein as the “vehicle 1300”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1300 may be capable of functionality in accordance with one or more of Level 3-Level 5 of the autonomous driving levels. The vehicle 1300 may be capable of functionality in accordance with one or more of Level 1-Level 5 of the autonomous driving levels. For example, the vehicle 1300 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1300 or other machine, such as being fully autonomous, being highly autonomous, being conditionally autonomous, being partially autonomous, providing assistive autonomy, being semi-autonomous, being primarily autonomous, or other designation.

The vehicle 1300 may include components such as a chassis, a vehicle body, wheels (e.g., 2, 4, 6, 8, 18, etc.), tires, axles, and other components of a vehicle. The vehicle 1300 may include a propulsion system 1350, such as an internal combustion engine, hybrid electric power plant, an all-electric engine, and/or another propulsion system type. The propulsion system 1350 may be connected to a drive train of the vehicle 1300, which may include a transmission, to enable the propulsion of the vehicle 1300. The propulsion system 1350 may be controlled in response to receiving signals from the throttle/accelerator 1352.

A steering system 1354, which may include a steering wheel, may be used to steer the vehicle 1300 (e.g., along a desired path or route) when the propulsion system 1350 is operating (e.g., when the vehicle is in motion). The steering system 1354 may receive signals from a steering actuator 1356. The steering wheel may be optional for full automation (Level 5) functionality.

The brake sensor system 1346 may be used to operate the vehicle brakes in response to receiving signals from the brake actuators 1348 and/or brake sensors.

Controller(s) 1336, which may include one or more system on chips (SoCs) 1304 (FIG. 13C) and/or GPU(s), may provide signals (e.g., representative of commands) to one or more components and/or systems of the vehicle 1300. For example, the controller(s) may send signals to operate the vehicle brakes via one or more brake actuators 1348, to operate the steering system 1354 via one or more steering actuators 1356, to operate the propulsion system 1350 via one or more throttle/accelerators 1352. The controller(s) 1336 may include one or more onboard (e.g., integrated) computing devices (e.g., supercomputers) that process sensor signals, and output operation commands (e.g., signals representing commands) to enable autonomous driving and/or to assist a human driver in driving the vehicle 1300. The controller(s) 1336 may include a first controller 1336 for autonomous driving functions, a second controller 1336 for functional safety functions, a third controller 1336 for artificial intelligence functionality (e.g., computer vision), a fourth controller 1336 for infotainment functionality, a fifth controller 1336 for redundancy in emergency conditions, and/or other controllers. In some examples, a single controller 1336 may handle two or more of the above functionalities, two or more controllers 1336 may handle a single functionality, and/or any combination thereof.

The controller(s) 1336 may provide the signals for controlling one or more components and/or systems of the vehicle 1300 in response to sensor data received from one or more sensors (e.g., sensor inputs). The sensor data may be received from, for example and without limitation, global navigation satellite systems (“GNSS”) sensor(s) 1358 (e.g., Global Positioning System sensor(s)), RADAR sensor(s) 1360, ultrasonic sensor(s) 1362, LIDAR sensor(s) 1364, inertial measurement unit (IMU) sensor(s) 1366 (e.g., accelerometer(s), gyroscope(s), magnetic compass(es), magnetometer(s), etc.), microphone(s) 1396, stereo camera(s) 1368, wide-view camera(s) 1370 (e.g., fisheye cameras), infrared camera(s) 1372, surround camera(s) 1374 (e.g., 360 degree cameras), long-range and/or mid-range camera(s) 1398, speed sensor(s) 1344 (e.g., for measuring the speed of the vehicle 1300), vibration sensor(s) 1342, steering sensor(s) 1340, brake sensor(s) (e.g., as part of the brake sensor system 1346), and/or other sensor types.

One or more of the controller(s) 1336 may receive inputs (e.g., represented by input data) from an instrument cluster 1332 of the vehicle 1300 and provide outputs (e.g., represented by output data, display data, etc.) via a human-machine interface (HMI) display 1334, an audible annunciator, a loudspeaker, and/or via other components of the vehicle 1300. The outputs may include information such as vehicle velocity, speed, time, map data (e.g., the High Definition (“HD”) map 1322 of FIG. 13C), location data (e.g., the vehicle's 1300 location, such as on a map), direction, location of other vehicles (e.g., an occupancy grid), information about objects and status of objects as perceived by the controller(s) 1336, etc. For example, the HMI display 1334 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1300 further includes a network interface 1324 which may use one or more wireless antenna(s) 1326 and/or modem(s) to communicate over one or more networks. For example, the network interface 1324 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1326 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 13B is an example of camera locations and fields of view for the example autonomous vehicle 1300 of FIG. 13A, in accordance with some embodiments of the present disclosure. The cameras and respective fields of view are one example embodiment and are not intended to be limiting. For example, additional and/or alternative cameras may be included and/or the cameras may be located at different locations on the vehicle 1300.

The camera types for the cameras may include, but are not limited to, digital cameras that may be adapted for use with the components and/or systems of the vehicle 1300. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1300 (e.g., front-facing cameras) may be used for surround view, to help identify forward facing paths and obstacles, as well aid in, with the help of one or more controllers 1336 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1370 that may be used to perceive objects coming into view from the periphery (e.g., pedestrians, crossing traffic or bicycles). Although only one wide-view camera is illustrated in FIG. 13B, there may be any number (including zero) of wide-view cameras 1370 on the vehicle 1300. In addition, any number of long-range camera(s) 1398 (e.g., a long-view stereo camera pair) may be used for depth-based object detection, especially for objects for which a neural network has not yet been trained. The long-range camera(s) 1398 may also be used for object detection and classification, as well as basic object tracking.

Any number of stereo cameras 1368 may also be included in a front-facing configuration. In at least one embodiment, one or more of stereo camera(s) 1368 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1368 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1368 may be used in addition to, or alternatively from, those described herein.

Cameras with a field of view that include portions of the environment to the side of the vehicle 1300 (e.g., side-view cameras) may be used for surround view, providing information used to create and update the occupancy grid, as well as to generate side impact collision warnings. For example, surround camera(s) 1374 (e.g., four surround cameras 1374 as illustrated in FIG. 13B) may be positioned to on the vehicle 1300. The surround camera(s) 1374 may include wide-view camera(s) 1370, fisheye camera(s), 360 degree camera(s), and/or the like. Four example, four fisheye cameras may be positioned on the vehicle's front, rear, and sides. In an alternative arrangement, the vehicle may use three surround camera(s) 1374 (e.g., left, right, and rear), and may leverage one or more other camera(s) (e.g., a forward-facing camera) as a fourth surround view camera.

Cameras with a field of view that include portions of the environment to the rear of the vehicle 1300 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1398, stereo camera(s) 1368), infrared camera(s) 1372, etc.), as described herein.

FIG. 13C is a block diagram of an example system architecture for the example autonomous vehicle 1300 of FIG. 13A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1300 in FIG. 13C are illustrated as being connected via bus 1302. The bus 1302 may include a Controller Area Network (CAN) data interface (alternatively referred to herein as a “CAN bus”). A CAN may be a network inside the vehicle 1300 used to aid in control of various features and functionality of the vehicle 1300, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1302 is described herein as being a CAN bus, this is not intended to be limiting. For example, in addition to, or alternatively from, the CAN bus, FlexRay and/or Ethernet may be used. Additionally, although a single line is used to represent the bus 1302, this is not intended to be limiting. For example, there may be any number of busses 1302, which may include one or more CAN busses, one or more FlexRay busses, one or more Ethernet busses, and/or one or more other types of busses using a different protocol. In some examples, two or more busses 1302 may be used to perform different functions, and/or may be used for redundancy. For example, a first bus 1302 may be used for collision avoidance functionality and a second bus 1302 may be used for actuation control. In any example, each bus 1302 may communicate with any of the components of the vehicle 1300, and two or more busses 1302 may communicate with the same components. In some examples, each SoC 1304, each controller 1336, and/or each computer within the vehicle may have access to the same input data (e.g., inputs from sensors of the vehicle 1300), and may be connected to a common bus, such the CAN bus.

The vehicle 1300 may include one or more controller(s) 1336, such as those described herein with respect to FIG. 13A. The controller(s) 1336 may be used for a variety of functions. The controller(s) 1336 may be coupled to any of the various other components and systems of the vehicle 1300, and may be used for control of the vehicle 1300, artificial intelligence of the vehicle 1300, infotainment for the vehicle 1300, and/or the like.

The vehicle 1300 may include a system(s) on a chip (SoC) 1304. The SoC 1304 may include CPU(s) 1306, GPU(s) 1308, processor(s) 1310, cache(s) 1312, accelerator(s) 1314, data store(s) 1316, and/or other components and features not illustrated. The SoC(s) 1304 may be used to control the vehicle 1300 in a variety of platforms and systems. For example, the SoC(s) 1304 may be combined in a system (e.g., the system of the vehicle 1300) with an HD map 1322 which may obtain map refreshes and/or updates via a network interface 1324 from one or more servers (e.g., server(s) 1378 of FIG. 13D).

The CPU(s) 1306 may include a CPU cluster or CPU complex (alternatively referred to herein as a “CCPLEX”). The CPU(s) 1306 may include multiple cores and/or L2 caches. For example, in some embodiments, the CPU(s) 1306 may include eight cores in a coherent multi-processor configuration. In some embodiments, the CPU(s) 1306 may include four dual-core clusters where each cluster has a dedicated L2 cache (e.g., a 2 MB L2 cache). The CPU(s) 1306 (e.g., the CCPLEX) may be configured to support simultaneous cluster operation enabling any combination of the clusters of the CPU(s) 1306 to be active at any given time.

The CPU(s) 1306 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1306 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1308 may include an integrated GPU (alternatively referred to herein as an “iGPU”). The GPU(s) 1308 may be programmable and may be efficient for parallel workloads. The GPU(s) 1308, in some examples, may use an enhanced tensor instruction set. The GPU(s) 1308 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1308 may include at least eight streaming microprocessors. The GPU(s) 1308 may use compute application programming interface(s) (API(s)). In addition, the GPU(s) 1308 may use one or more parallel computing platforms and/or programming models (e.g., NVIDIA's CUDA).

The GPU(s) 1308 may be power-optimized for best performance in automotive and embedded use cases. For example, the GPU(s) 1308 may be fabricated on a Fin field-effect transistor (FinFET). However, this is not intended to be limiting and the GPU(s) 1308 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1308 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1308 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1308 to access the CPU(s) 1306 page tables directly. In such examples, when the GPU(s) 1308 memory management unit (MMU) experiences a miss, an address translation request may be transmitted to the CPU(s) 1306. In response, the CPU(s) 1306 may look in its page tables for the virtual-to-physical mapping for the address and transmits the translation back to the GPU(s) 1308. As such, unified memory technology may allow a single unified virtual address space for memory of both the CPU(s) 1306 and the GPU(s) 1308, thereby simplifying the GPU(s) 1308 programming and porting of applications to the GPU(s) 1308.

In addition, the GPU(s) 1308 may include an access counter that may keep track of the frequency of access of the GPU(s) 1308 to memory of other processors. The access counter may help ensure that memory pages are moved to the physical memory of the processor that is accessing the pages most frequently.

The SoC(s) 1304 may include any number of cache(s) 1312, including those described herein. For example, the cache(s) 1312 may include an L3 cache that is available to both the CPU(s) 1306 and the GPU(s) 1308 (e.g., that is connected both the CPU(s) 1306 and the GPU(s) 1308). The cache(s) 1312 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1304 may include an arithmetic logic unit(s) (ALU(s)) which may be leveraged in performing processing with respect to any of the variety of tasks or operations of the vehicle 1300—such as processing DNNs. In addition, the SoC(s) 1304 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1306 and/or GPU(s) 1308.

The SoC(s) 1304 may include one or more accelerators 1314 (e.g., hardware accelerators, software accelerators, or a combination thereof). For example, the SoC(s) 1304 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1308 and to off-load some of the tasks of the GPU(s) 1308 (e.g., to free up more cycles of the GPU(s) 1308 for performing other tasks). As an example, the accelerator(s) 1314 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1314 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1308, and by using an inference accelerator, for example, a designer may target either the DLA(s) or the GPU(s) 1308 for any function. For example, the designer may focus processing of CNNs and floating point operations on the DLA(s) and leave other functions to the GPU(s) 1308 and/or other accelerator(s) 1314.

The accelerator(s) 1314 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1306. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1314 (e.g., the hardware acceleration cluster) may include a computer vision network on-chip and SRAM, for providing a high-bandwidth, low latency SRAM for the accelerator(s) 1314. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1304 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1314 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1366 output that correlates with the vehicle 1300 orientation, distance, 3D location estimates of the object obtained from the neural network and/or other sensors (e.g., LIDAR sensor(s) 1364 or RADAR sensor(s) 1360), among others.

The SoC(s) 1304 may include data store(s) 1316 (e.g., memory). The data store(s) 1316 may be on-chip memory of the SoC(s) 1304, which may store neural networks to be executed on the GPU and/or the DLA. In some examples, the data store(s) 1316 may be large enough in capacity to store multiple instances of neural networks for redundancy and safety. The data store(s) 1312 may comprise L2 or L3 cache(s) 1312. Reference to the data store(s) 1316 may include reference to the memory associated with the PVA, DLA, and/or other accelerator(s) 1314, as described herein.

The SoC(s) 1304 may include one or more processor(s) 1310 (e.g., embedded processors). The processor(s) 1310 may include a boot and power management processor that may be a dedicated processor and subsystem to handle boot power and management functions and related security enforcement. The boot and power management processor may be a part of the SoC(s) 1304 boot sequence and may provide runtime power management services. The boot power and management processor may provide clock and voltage programming, assistance in system low power state transitions, management of SoC(s) 1304 thermals and temperature sensors, and/or management of the SoC(s) 1304 power states. Each temperature sensor may be implemented as a ring-oscillator whose output frequency is proportional to temperature, and the SoC(s) 1304 may use the ring-oscillators to detect temperatures of the CPU(s) 1306, GPU(s) 1308, and/or accelerator(s) 1314. If temperatures are determined to exceed a threshold, the boot and power management processor may enter a temperature fault routine and put the SoC(s) 1304 into a lower power state and/or put the vehicle 1300 into a chauffeur to safe stop mode (e.g., bring the vehicle 1300 to a safe stop).

The processor(s) 1310 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1310 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1310 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1310 may further include a real-time camera engine that may include a dedicated processor subsystem for handling real-time camera management.

The processor(s) 1310 may further include a high-dynamic range signal processor that may include an image signal processor that is a hardware engine that is part of the camera processing pipeline.

The processor(s) 1310 may include a video image compositor that may be a processing block (e.g., implemented on a microprocessor) that implements video post-processing functions needed by a video playback application to produce the final image for the player window. The video image compositor may perform lens distortion correction on wide-view camera(s) 1370, surround camera(s) 1374, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1308 is not required to continuously render new surfaces. Even when the GPU(s) 1308 is powered on and active doing 3D rendering, the video image compositor may be used to offload the GPU(s) 1308 to improve performance and responsiveness.

The SoC(s) 1304 may further include a mobile industry processor interface (MIPI) camera serial interface for receiving video and input from cameras, a high-speed interface, and/or a video input block that may be used for camera and related pixel input functions. The SoC(s) 1304 may further include an input/output controller(s) that may be controlled by software and may be used for receiving I/O signals that are uncommitted to a specific role.

The SoC(s) 1304 may further include a broad range of peripheral interfaces to enable communication with peripherals, audio codecs, power management, and/or other devices. The SoC(s) 1304 may be used to process data from cameras (e.g., connected over Gigabit Multimedia Serial Link and Ethernet), sensors (e.g., LIDAR sensor(s) 1364, RADAR sensor(s) 1360, etc. that may be connected over Ethernet), data from bus 1302 (e.g., speed of vehicle 1300, steering wheel position, etc.), data from GNSS sensor(s) 1358 (e.g., connected over Ethernet or CAN bus). The SoC(s) 1304 may further include dedicated high-performance mass storage controllers that may include their own DMA engines, and that may be used to free the CPU(s) 1306 from routine data management tasks.

The SoC(s) 1304 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1304 may be faster, more reliable, and even more energy-efficient and space-efficient than conventional systems. For example, the accelerator(s) 1314, when combined with the CPU(s) 1306, the GPU(s) 1308, and the data store(s) 1316, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1320) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1308.

In some examples, a CNN for facial recognition and vehicle owner identification may use data from camera sensors to identify the presence of an authorized driver and/or owner of the vehicle 1300. The always on sensor processing engine may be used to unlock the vehicle when the owner approaches the driver door and turn on the lights, and, in security mode, to disable the vehicle when the owner leaves the vehicle. In this way, the SoC(s) 1304 provide for security against theft and/or carjacking.

In another example, a CNN for emergency vehicle detection and identification may use data from microphones 1396 to detect and identify emergency vehicle sirens. In contrast to conventional systems, that use general classifiers to detect sirens and manually extract features, the SoC(s) 1304 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1358. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1362, until the emergency vehicle(s) passes.

The vehicle may include a CPU(s) 1318 (e.g., discrete CPU(s), or dCPU(s)), that may be coupled to the SoC(s) 1304 via a high-speed interconnect (e.g., PCIe). The CPU(s) 1318 may include an X86 processor, for example. The CPU(s) 1318 may be used to perform any of a variety of functions, including arbitrating potentially inconsistent results between ADAS sensors and the SoC(s) 1304, and/or monitoring the status and health of the controller(s) 1336 and/or infotainment SoC 1330, for example.

The vehicle 1300 may include a GPU(s) 1320 (e.g., discrete GPU(s), or dGPU(s)), that may be coupled to the SoC(s) 1304 via a high-speed interconnect (e.g., NVIDIA's NVLINK). The GPU(s) 1320 may provide additional artificial intelligence functionality, such as by executing redundant and/or different neural networks, and may be used to train and/or update neural networks based on input (e.g., sensor data) from sensors of the vehicle 1300.

The vehicle 1300 may further include the network interface 1324 which may include one or more wireless antennas 1326 (e.g., one or more wireless antennas for different communication protocols, such as a cellular antenna, a Bluetooth antenna, etc.). The network interface 1324 may be used to enable wireless connectivity over the Internet with the cloud (e.g., with the server(s) 1378 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1300 information about vehicles in proximity to the vehicle 1300 (e.g., vehicles in front of, on the side of, and/or behind the vehicle 1300). This functionality may be part of a cooperative adaptive cruise control functionality of the vehicle 1300.

The network interface 1324 may include a SoC that provides modulation and demodulation functionality and enables the controller(s) 1336 to communicate over wireless networks. The network interface 1324 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1300 may further include data store(s) 1328 which may include off-chip (e.g., off the SoC(s) 1304) storage. The data store(s) 1328 may include one or more storage elements including RAM, SRAM, DRAM, VRAM, Flash, hard disks, and/or other components and/or devices that may store at least one bit of data.

The vehicle 1300 may further include GNSS sensor(s) 1358. The GNSS sensor(s) 1358 (e.g., GPS, assisted GPS sensors, differential GPS (DGPS) sensors, etc.), to assist in mapping, perception, occupancy grid generation, and/or path planning functions. Any number of GNSS sensor(s) 1358 may be used, including, for example and without limitation, a GPS using a USB connector with an Ethernet to Serial (RS-232) bridge.

The vehicle 1300 may further include RADAR sensor(s) 1360. The RADAR sensor(s) 1360 may be used by the vehicle 1300 for long-range vehicle detection, even in darkness and/or severe weather conditions. RADAR functional safety levels may be ASIL B. The RADAR sensor(s) 1360 may use the CAN and/or the bus 1302 (e.g., to transmit data generated by the RADAR sensor(s) 1360) for control and to access object tracking data, with access to Ethernet to access raw data in some examples. A wide variety of RADAR sensor types may be used. For example, and without limitation, the RADAR sensor(s) 1360 may be suitable for front, rear, and side RADAR use. In some example, Pulse Doppler RADAR sensor(s) are used.

The RADAR sensor(s) 1360 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1360 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1300 surroundings at higher speeds with minimal interference from traffic in adjacent lanes. The other two antennae may expand the field of view, making it possible to quickly detect vehicles entering or leaving the vehicle's 1300 lane.

Mid-range RADAR systems may include, as an example, a range of up to 1360 m (front) or 80 m (rear), and a field of view of up to 42 degrees (front) or 1350 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1300 may further include ultrasonic sensor(s) 1362. The ultrasonic sensor(s) 1362, which may be positioned at the front, back, and/or the sides of the vehicle 1300, may be used for park assist and/or to create and update an occupancy grid. A wide variety of ultrasonic sensor(s) 1362 may be used, and different ultrasonic sensor(s) 1362 may be used for different ranges of detection (e.g., 2.5 m, 4 m). The ultrasonic sensor(s) 1362 may operate at functional safety levels of ASIL B.

The vehicle 1300 may include LIDAR sensor(s) 1364. The LIDAR sensor(s) 1364 may be used for object and pedestrian detection, emergency braking, collision avoidance, and/or other functions. The LIDAR sensor(s) 1364 may be functional safety level ASIL B. In some examples, the vehicle 1300 may include multiple LIDAR sensors 1364 (e.g., two, four, six, etc.) that may use Ethernet (e.g., to provide data to a Gigabit Ethernet switch).

In some examples, the LIDAR sensor(s) 1364 may be capable of providing a list of objects and their distances for a 360-degree field of view. Commercially available LIDAR sensor(s) 1364 may have an advertised range of approximately 1300 m, with an accuracy of 2 cm-3 cm, and with support for a 1300 Mbps Ethernet connection, for example. In some examples, one or more non-protruding LIDAR sensors 1364 may be used. In such examples, the LIDAR sensor(s) 1364 may be implemented as a small device that may be embedded into the front, rear, sides, and/or corners of the vehicle 1300. The LIDAR sensor(s) 1364, in such examples, may provide up to a 120-degree horizontal and 35-degree vertical field-of-view, with a 200 m range even for low-reflectivity objects. Front-mounted LIDAR sensor(s) 1364 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1300. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1364 may be less susceptible to motion blur, vibration, and/or shock.

The vehicle may further include IMU sensor(s) 1366. The IMU sensor(s) 1366 may be located at a center of the rear axle of the vehicle 1300, in some examples. The IMU sensor(s) 1366 may include, for example and without limitation, an accelerometer(s), a magnetometer(s), a gyroscope(s), a magnetic compass(es), and/or other sensor types. In some examples, such as in six-axis applications, the IMU sensor(s) 1366 may include accelerometers and gyroscopes, while in nine-axis applications, the IMU sensor(s) 1366 may include accelerometers, gyroscopes, and magnetometers.

In some embodiments, the IMU sensor(s) 1366 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1366 may enable the vehicle 1300 to estimate heading without requiring input from a magnetic sensor by directly observing and correlating the changes in velocity from GPS to the IMU sensor(s) 1366. In some examples, the IMU sensor(s) 1366 and the GNSS sensor(s) 1358 may be combined in a single integrated unit.

The vehicle may include microphone(s) 1396 placed in and/or around the vehicle 1300. The microphone(s) 1396 may be used for emergency vehicle detection and identification, among other things.

The vehicle may further include any number of camera types, including stereo camera(s) 1368, wide-view camera(s) 1370, infrared camera(s) 1372, surround camera(s) 1374, long-range and/or mid-range camera(s) 1398, and/or other camera types. The cameras may be used to capture image data around an entire periphery of the vehicle 1300. The types of cameras used depends on the embodiments and requirements for the vehicle 1300, and any combination of camera types may be used to provide the necessary coverage around the vehicle 1300. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 13A and FIG. 13B.

The vehicle 1300 may further include vibration sensor(s) 1342. The vibration sensor(s) 1342 may measure vibrations of components of the vehicle, such as the axle(s). For example, changes in vibrations may indicate a change in road surfaces. In another example, when two or more vibration sensors 1342 are used, the differences between the vibrations may be used to determine friction or slippage of the road surface (e.g., when the difference in vibration is between a power-driven axle and a freely rotating axle).

The vehicle 1300 may include an ADAS system 1338. The ADAS system 1338 may include a SoC, in some examples. The ADAS system 1338 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1360, LIDAR sensor(s) 1364, and/or a camera(s). The ACC systems may include longitudinal ACC and/or lateral ACC. Longitudinal ACC monitors and controls the distance to the vehicle immediately ahead of the vehicle 1300 and automatically adjust the vehicle speed to maintain a safe distance from vehicles ahead. Lateral ACC performs distance keeping, and advises the vehicle 1300 to change lanes when necessary. Lateral ACC is related to other ADAS applications such as LCA and CWS.

CACC uses information from other vehicles that may be received via the network interface 1324 and/or the wireless antenna(s) 1326 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1300), while the I2V communication concept provides information about traffic further ahead. CACC systems may include either or both I2V and V2V information sources. Given the information of the vehicles ahead of the vehicle 1300, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1360, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1360, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1300 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1300 if the vehicle 1300 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1360, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1300 is backing up. Some RCTW systems include AEB to ensure that the vehicle brakes are applied to avoid a crash. RCTW systems may use one or more rear-facing RADAR sensor(s) 1360, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1300, the vehicle 1300 itself must, in the case of conflicting results, decide whether to heed the result from a primary computer or a secondary computer (e.g., a first controller 1336 or a second controller 1336). For example, in some embodiments, the ADAS system 1338 may be a backup and/or secondary computer for providing perception information to a backup computer rationality module. The backup computer rationality monitor may run a redundant diverse software on hardware components to detect faults in perception and dynamic driving tasks. Outputs from the ADAS system 1338 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1304.

In other examples, ADAS system 1338 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1338 may be fed into the primary computer's perception block and/or the primary computer's dynamic driving task block. For example, if the ADAS system 1338 indicates a forward crash warning due to an object immediately ahead, the perception block may use this information when identifying objects. In other examples, the secondary computer may have its own neural network which is trained and thus reduces the risk of false positives, as described herein.

The vehicle 1300 may further include the infotainment SoC 1330 (e.g., an in-vehicle infotainment system (IVI)). Although illustrated and described as a SoC, the infotainment system may not be a SoC, and may include two or more discrete components. The infotainment SoC 1330 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1300. For example, the infotainment SoC 1330 may radios, disk players, navigation systems, video players, USB and Bluetooth connectivity, carputers, in-car entertainment, Wi-Fi, steering wheel audio controls, hands free voice control, a heads-up display (HUD), an HMI display 1334, a telematics device, a control panel (e.g., for controlling and/or interacting with various components, features, and/or systems), and/or other components. The infotainment SoC 1330 may further be used to provide information (e.g., visual and/or audible) to a user(s) of the vehicle, such as information from the ADAS system 1338, autonomous driving information such as planned vehicle maneuvers, trajectories, surrounding environment information (e.g., intersection information, vehicle information, road information, etc.), and/or other information.

The infotainment SoC 1330 may include GPU functionality. The infotainment SoC 1330 may communicate over the bus 1302 (e.g., CAN bus, Ethernet, etc.) with other devices, systems, and/or components of the vehicle 1300. In some examples, the infotainment SoC 1330 may be coupled to a supervisory MCU such that the GPU of the infotainment system may perform some self-driving functions in the event that the primary controller(s) 1336 (e.g., the primary and/or backup computers of the vehicle 1300) fail. In such an example, the infotainment SoC 1330 may put the vehicle 1300 into a chauffeur to safe stop mode, as described herein.

The vehicle 1300 may further include an instrument cluster 1332 (e.g., a digital dash, an electronic instrument cluster, a digital instrument panel, etc.). The instrument cluster 1332 may include a controller and/or supercomputer (e.g., a discrete controller or supercomputer). The instrument cluster 1332 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1330 and the instrument cluster 1332. In other words, the instrument cluster 1332 may be included as part of the infotainment SoC 1330, or vice versa.

FIG. 13D is a system diagram for communication between cloud-based server(s) and the example autonomous vehicle 1300 of FIG. 13A, in accordance with some embodiments of the present disclosure. The system 1376 may include server(s) 1378, network(s) 1390, and vehicles, including the vehicle 1300. The server(s) 1378 may include a plurality of GPUs 1384(A)-1384(H) (collectively referred to herein as GPUs 1384), PCIe switches 1382(A)-1382(H) (collectively referred to herein as PCIe switches 1382), and/or CPUs 1380(A)-1380(B) (collectively referred to herein as CPUs 1380). The GPUs 1384, the CPUs 1380, and the PCIe switches may be interconnected with high-speed interconnects such as, for example and without limitation, NVLink interfaces 1388 developed by NVIDIA and/or PCIe connections 1386. In some examples, the GPUs 1384 are connected via NVLink and/or NVSwitch SoC and the GPUs 1384 and the PCIe switches 1382 are connected via PCIe interconnects. Although eight GPUs 1384, two CPUs 1380, and two PCIe switches are illustrated, this is not intended to be limiting. Depending on the embodiment, each of the server(s) 1378 may include any number of GPUs 1384, CPUs 1380, and/or PCIe switches. For example, the server(s) 1378 may each include eight, sixteen, thirty-two, and/or more GPUs 1384.

The server(s) 1378 may receive, over the network(s) 1390 and from the vehicles, image data representative of images showing unexpected or changed road conditions, such as recently commenced road-work. The server(s) 1378 may transmit, over the network(s) 1390 and to the vehicles, neural networks 1392, updated neural networks 1392, and/or map information 1394, including information regarding traffic and road conditions. The updates to the map information 1394 may include updates for the HD map 1322, such as information regarding construction sites, potholes, detours, flooding, and/or other obstructions. In some examples, the neural networks 1392, the updated neural networks 1392, and/or the map information 1394 may have resulted from new training and/or experiences represented in data received from any number of vehicles in the environment, and/or based on training performed at a datacenter (e.g., using the server(s) 1378 and/or other servers).

The server(s) 1378 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1390, and/or the machine learning models may be used by the server(s) 1378 to remotely monitor the vehicles.

In some examples, the server(s) 1378 may receive data from the vehicles and apply the data to up-to-date real-time neural networks for real-time intelligent inferencing. The server(s) 1378 may include deep-learning supercomputers and/or dedicated AI computers powered by GPU(s) 1384, such as a DGX and DGX Station machines developed by NVIDIA. However, in some examples, the server(s) 1378 may include deep learning infrastructure that use only CPU-powered datacenters.

The deep-learning infrastructure of the server(s) 1378 may be capable of fast, real-time inferencing, and may use that capability to evaluate and verify the health of the processors, software, and/or associated hardware in the vehicle 1300. For example, the deep-learning infrastructure may receive periodic updates from the vehicle 1300, such as a sequence of images and/or objects that the vehicle 1300 has located in that sequence of images (e.g., via computer vision and/or other machine learning object classification techniques). The deep-learning infrastructure may run its own neural network to identify the objects and compare them with the objects identified by the vehicle 1300 and, if the results do not match and the infrastructure concludes that the AI in the vehicle 1300 is malfunctioning, the server(s) 1378 may transmit a signal to the vehicle 1300 instructing a fail-safe computer of the vehicle 1300 to assume control, notify the passengers, and complete a safe parking maneuver.

For inferencing, the server(s) 1378 may include the GPU(s) 1384 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 14 is a block diagram of an example computing device(s) 1400 suitable for use in implementing some embodiments of the present disclosure. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s)), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). In other words, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a simulated image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that enable the computing device 1400 to communicate with other computing devices via an electronic communication network, included wired and/or wireless communications. The communication interface 1410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may enable the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that enable detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to enable the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

### Example Data Center

FIG. 15 illustrates an example data center 1500 that may be used in at least one embodiments of the present disclosure. The data center 1500 may include a data center infrastructure layer 1510, a framework layer 1520, a software layer 1530, and/or an application layer 1540.

As shown in FIG. 15, the data center infrastructure layer 1510 may include a resource orchestrator 1512, grouped computing resources 1514, and node computing resources (“node C.R.s”) 1516(1)-1516(N), where “N” represents any whole, positive integer. In at least one embodiment, node C.R.s 1516(1)-1516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1516(1)-1516(N) may correspond to a server having one or more of the above-mentioned computing resources. In addition, in some embodiments, the node C.R.s 1516(1)-15161(N) may include one or more virtual components, such as vGPUs, vCPUs, and/or the like, and/or one or more of the node C.R.s 1516(1)-1516(N) may correspond to a virtual machine (VM).

In at least one embodiment, grouped computing resources 1514 may include separate groupings of node C.R.s 1516 housed within one or more racks (not shown), or many racks housed in data centers at various geographical locations (also not shown). Separate groupings of node C.R.s 1516 within grouped computing resources 1514 may include grouped compute, network, memory or storage resources that may be configured or allocated to support one or more workloads. In at least one embodiment, several node C.R.s 1516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1512 may configure or otherwise control one or more node C.R.s 1516(1)-1516(N) and/or grouped computing resources 1514. In at least one embodiment, resource orchestrator 1512 may include a software design infrastructure (SDI) management entity for the data center 1500. The resource orchestrator 1512 may include hardware, software, or some combination thereof.

In at least one embodiment, as shown in FIG. 15, framework layer 1520 may include a job scheduler 1533, a configuration manager 1534, a resource manager 1536, and/or a distributed file system 1538. The framework layer 1520 may include a framework to support software 1532 of software layer 1530 and/or one or more application(s) 1542 of application layer 1540. The software 1532 or application(s) 1542 may respectively include web-based service software or applications, such as those provided by Amazon Web Services, Google Cloud and Microsoft Azure. The framework layer 1520 may be, but is not limited to, a type of free and open-source software web application framework such as Apache Spark™ (hereinafter “Spark”) that may utilize distributed file system 1538 for large-scale data processing (e.g., “big data”). In at least one embodiment, job scheduler 1533 may include a Spark driver to facilitate scheduling of workloads supported by various layers of data center 1500. The configuration manager 1534 may be capable of configuring different layers such as software layer 1530 and framework layer 1520 including Spark and distributed file system 1538 for supporting large-scale data processing. The resource manager 1536 may be capable of managing clustered or grouped computing resources mapped to or allocated for support of distributed file system 1538 and job scheduler 1533. In at least one embodiment, clustered or grouped computing resources may include grouped computing resource 1514 at data center infrastructure layer 1510. The resource manager 1536 may coordinate with resource orchestrator 1512 to manage these mapped or allocated computing resources.

In at least one embodiment, software 1532 included in software layer 1530 may include software used by at least portions of node C.R.s 1516(1)-1516(N), grouped computing resources 1514, and/or distributed file system 1538 of framework layer 1520. One or more types of software may include, but are not limited to, Internet web page search software, e-mail virus scan software, database software, and streaming video content software.

In at least one embodiment, application(s) 1542 included in application layer 1540 may include one or more types of applications used by at least portions of node C.R.s 1516(1)-1516(N), grouped computing resources 1514, and/or distributed file system 1538 of framework layer 1520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1534, resource manager 1536, and resource orchestrator 1512 may implement any number and type of self-modifying actions based on any amount and type of data acquired in any technically feasible fashion. Self-modifying actions may relieve a data center operator of data center 1500 from making possibly bad configuration decisions and possibly avoiding underutilized and/or poor performing portions of a data center.

The data center 1500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1500. In at least one embodiment, trained or deployed machine learning models corresponding to one or more neural networks may be used to infer or predict information using resources described above with respect to the data center 1500 by using weight parameters calculated through one or more training techniques, such as but not limited to those described herein.

In at least one embodiment, the data center 1500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1400 of FIG. 14 - e.g., each device may include similar components, features, and/or functionality of the computing device(s) 1400. In addition, where backend devices (e.g., servers, NAS, etc.) are implemented, the backend devices may be included as part of a data center 1500, an example of which is described in more detail herein with respect to FIG. 15.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments - in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1400 described herein with respect to FIG. 14. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: determining, based at least on image data representing one or more objects located within a space, one or more segmentation masks associated with the one or more objects; determining, based at least on the one or more segmentation masks, an object from the one or more objects; determining a pose associated with the object as located within the space; determining, based at least on the pose associated with the object, a motion path associated with removing the object from the space; and causing, using the motion path, a machine to remove the object from the space.
B: The method of paragraph A, wherein the determining the object from the one or more objects comprises: determining one or more scores associated with the one or more segmentation masks; determining that a segmentation mask from the one or more segmentation masks is associated with a highest score of the one or more scores; and determining the segmentation mask is associated with the object.
C: The method of paragraph B, further comprising at least one of: determining one or more first scores based at least on one or more differences between the one or more segmentation masks and a reference segmentation mask associated with the one or more objects; or determining one or more second scores based at least on comparing one or more areas of the one or more segmentation masks to one or more threshold areas, wherein the one or more scores are determined based at least on at least one of the one or more first scores or the one or more second scores.
D: The method of any one of paragraphs A-C, wherein the determining the pose associated with the object as located within the space comprises: applying, to one or more machine learning models, input data representing at least one or more images represented by the image data, a segmentation mask of the one or more segmentation masks that is associated with the object, and a mesh of the object; and determining, based at least on the one or more machine learning models processing the input data, the pose associated with the object as located within the space.
E: The method of any one of paragraphs A-D, further comprising: determining a first point cloud based at least on the pose associated with the object; determining a second point cloud associated with a mesh of the one or more objects; and determining a refined pose associated with the object based at least on the first point cloud and the second point cloud, wherein the determining the motion path for removing the object from the space is based at least on the refined pose associated with the object.
F: The method of any one of paragraphs A-E, further comprising: determining that the machine satisfies a collision-check when moving along the motion path, wherein the causing the machine to remove the object from the space using the motion path is based at least on the machine satisfying the collision-check.
G: The method of paragraph F, wherein the determining that the machine satisfies the collision-check when performing the motion path comprises: determining a first pose that is a first distance from the object along the motion path; determining a second pose that is a second distance from the object along the motion path; and determining that the machine does not collide with any physical portions of the space when in the first pose and the second pose.
H: The method of any one of paragraphs A-G, further comprising: determining one or more axes associated with one or more motion paths for removing the object; and determining a ranking associated with the one or more motion paths based at least on the one or more axes and a reference axis, wherein the determining the motion path is further based at least on the ranking.
I: The method of any one of paragraphs A-H, further comprising: determining one or more second segmentation masks associated with one or more failed collision-checks; and comparing the one or more segmentation masks with respect to the one or more second segmentation masks, wherein the determining the object is based at least on the comparing the one or more segmentation masks with respect to the one or more second segmentation masks.
J: A system comprising: one or more processors to: determine, based at least on sensor data representing one or more objects located within a space, an object from the one or more objects; determine at least a first pose that is a first distance from the object along a motion path and a second pose that is a second distance from the object along the motion path; determine, based at least on the first pose and the second pose, that the motion path satisfies a collision-check; and cause, based at least on the motion path satisfying the collision-check, a machine to navigate along the motion path to interact with the object.
K: The system of paragraph J, wherein the determination that the motion path satisfies the collision-check comprises: determining that the machine does not collide with at least one of physical features of the space or one or more second objects of the one or more objects when at the first pose; and determining that the machine does not collide with the at least one of the physical features of the space or the one or more second objects when at the second pose.
L: The system of either paragraph J or paragraph K, wherein the one or more processors are further to: determine one or more axes associated with one or more motion paths for interacting with the object; determine one or more scores associated with the one or more motion paths based at least on the one or more axes and a reference axis; an determine the motion path based at least on the one or more scores.
M: The system of any one of paragraphs J-L, wherein the one or more processors are further to: determine a pose associated with the object, wherein the at least the first pose and the second pose are determined based at least on the pose.
N: The system of paragraph M, wherein the one or more processors are further to: determine a first point cloud based at least on the pose associated with the object; determine a second point cloud associated with a mesh of the one or more objects; and determine a refined pose associated with the object based at least on the first point cloud and the second point cloud, wherein the at least the first pose and the second pose are determined based at least on the refined pose.
O: The system of any one of paragraphs J-N, wherein the determination of the object from the one or more objects comprises: determining, based at least on the sensor data, one or more segmentation masks associated with the one or more objects; and determining the object from the one or more objects based at least on the one or more segmentation masks.
P: The system of any one of paragraphs J-O, wherein the determination of the object from the one or more objects comprises: determining, based at least on the sensor data, one or more segmentation masks associated with the one or more objects; determining, based at least on a reference segmentation mask associated with the one or more objects, one or more scores associated with the one or more segmentation masks; and determining the object from the one or more objects based at least on the one or more scores.
Q: The system of any one of paragraphs J-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
R: One or more processors comprising: processing circuitry to: determine, based at least on sensor data representing one or more objects located within a space, one or more segmentation masks associated with the one or more objects; determine one or more scores associated with the one or more segmentation masks; determine, based at least on the one or more scores, an object from the one or more objects; and cause a machine to interact with the object.
S: The one or more processors of paragraph R, wherein the processing circuitry is further to: determine that a motion path associated with interacting with the object satisfies a collision-check, wherein the machine is caused to interact with the object using the motion path based at least on the motion path satisfying the collision-check.
T: The one or more processors of either paragraph R or paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

What is claimed is:

1. A method comprising:
determining, based at least on image data representing one or more objects located within a space, one or more segmentation masks associated with the one or more objects;
determining, based at least on the one or more segmentation masks, an object from the one or more objects;
determining a pose associated with the object as located within the space;
determining, based at least on the pose associated with the object, a motion path associated with removing the object from the space; and
causing, using the motion path, a machine to remove the object from the space.

2. The method of claim 1, wherein the determining the object from the one or more objects comprises:
determining one or more scores associated with the one or more segmentation masks;
determining that a segmentation mask from the one or more segmentation masks is associated with a highest score of the one or more scores; and
determining the segmentation mask is associated with the object.

3. The method of claim 2, further comprising at least one of:
determining one or more first scores based at least on one or more differences between the one or more segmentation masks and a reference segmentation mask associated with the one or more objects; or
determining one or more second scores based at least on comparing one or more areas of the one or more segmentation masks to one or more threshold areas,
wherein the one or more scores are determined based at least on at least one of the one or more first scores or the one or more second scores.

4. The method of claim 1, wherein the determining the pose associated with the object as located within the space comprises:
applying, to one or more machine learning models, input data representing at least one or more images represented by the image data, a segmentation mask of the one or more segmentation masks that is associated with the object, and a mesh of the object; and
determining, based at least on the one or more machine learning models processing the input data, the pose associated with the object as located within the space.

5. The method of claim 1, further comprising:
determining a first point cloud based at least on the pose associated with the object;
determining a second point cloud associated with a mesh of the one or more objects; and
determining a refined pose associated with the object based at least on the first point cloud and the second point cloud,
wherein the determining the motion path for removing the object from the space is based at least on the refined pose associated with the object.

6. The method of claim 1, further comprising:
determining that the machine satisfies a collision-check when moving along the motion path,
wherein the causing the machine to remove the object from the space using the motion path is based at least on the machine satisfying the collision-check.

7. The method of claim 6, wherein the determining that the machine satisfies the collision-check when performing the motion path comprises:
determining a first pose that is a first distance from the object along the motion path;
determining a second pose that is a second distance from the object along the motion path; and
determining that the machine does not collide with any physical portions of the space when in the first pose and the second pose.

8. The method of claim 1, further comprising:
determining one or more axes associated with one or more motion paths for removing the object; and
determining a ranking associated with the one or more motion paths based at least on the one or more axes and a reference axis,
wherein the determining the motion path is further based at least on the ranking.

9. The method of claim 1, further comprising:
determining one or more second segmentation masks associated with one or more failed collision-checks; and
comparing the one or more segmentation masks with respect to the one or more second segmentation masks,
wherein the determining the object is based at least on the comparing the one or more segmentation masks with respect to the one or more second segmentation masks.

10. A system comprising:
one or more processors to:
determine, based at least on sensor data representing one or more objects located within a space, an object from the one or more objects;
determine at least a first pose that is a first distance from the object along a motion path and a second pose that is a second distance from the object along the motion path;
determine, based at least on the first pose and the second pose, that the motion path satisfies a collision-check; and
cause, based at least on the motion path satisfying the collision-check, a machine to navigate along the motion path to interact with the object.

11. The system of claim 10, wherein the determination that the motion path satisfies the collision-check comprises:
determining that the machine does not collide with at least one of physical features of the space or one or more second objects of the one or more objects when at the first pose; and
determining that the machine does not collide with the at least one of the physical features of the space or the one or more second objects when at the second pose.

12. The system of claim 10, wherein the one or more processors are further to:
determine one or more axes associated with one or more motion paths for interacting with the object;
determine one or more scores associated with the one or more motion paths based at least on the one or more axes and a reference axis; and
determine the motion path based at least on the one or more scores.

13. The system of claim 10, wherein the one or more processors are further to:
determine a pose associated with the object,
wherein the at least the first pose and the second pose are determined based at least on the pose.

14. The system of claim 13, wherein the one or more processors are further to:
determine a first point cloud based at least on the pose associated with the object;
determine a second point cloud associated with a mesh of the one or more objects; and
determine a refined pose associated with the object based at least on the first point cloud and the second point cloud,
wherein the at least the first pose and the second pose are determined based at least on the refined pose.

15. The system of claim 10, wherein the determination of the object from the one or more objects comprises:
determining, based at least on the sensor data, one or more segmentation masks associated with the one or more objects; and
determining the object from the one or more objects based at least on the one or more segmentation masks.

16. The system of claim 10, wherein the determination of the object from the one or more objects comprises:
determining, based at least on the sensor data, one or more segmentation masks associated with the one or more objects;
determining, based at least on a reference segmentation mask associated with the one or more objects, one or more scores associated with the one or more segmentation masks; and
determining the object from the one or more objects based at least on the one or more scores.

17. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

18. One or more processors comprising:
processing circuitry to:
determine, based at least on sensor data representing one or more objects located within a space, one or more segmentation masks associated with the one or more objects;
determine one or more scores associated with the one or more segmentation masks;
determine, based at least on the one or more scores, an object from the one or more objects; and
cause a machine to interact with the object.

19. The one or more processors of claim 18, wherein the processing circuitry is further to:
determine that a motion path associated with interacting with the object satisfies a collision-check,
wherein the machine is caused to interact with the object using the motion path based at least on the motion path satisfying the collision-check.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
